(19) United States
(12) Patent Application Publication
(10) Pub. No.: US 2025/0220318 A1
(43) Pub. Date: Jul. 3, 2025

(54) SENSOR DEVICE AND METHOD FOR OPERATING A SENSOR DEVICE

(71) Applicant: Sony Semiconductor Solutions Corporation, Atsugi-shi, Kanagawa (JP)

(72) Inventors: Kensei JO, Stuttgart (DE); Samuel BRYNER, Stuttgart (DE)

(73) Assignee: Sony Semiconductor Solutions Corporation, Atsugi-shi, Kanagawa (JP)

(21) Appl. No.: 18/847,851

(22) PCT Filed: Mar. 1, 2023
(86) PCT No.: PCT/EP2023/055066

§ 371 Date: Sep. 17, 2024

(30) Foreign Application Priority Data
Mar. 30, 2022 (EP) 22165515.2

(51) Int. Cl. H04N 25/47; H04N 23/68; H04N 23/71; H04N 23/73; H04N 25/57; H04N 25/78

(52) U.S. Cl. CPC H04N 25/47; H04N 23/684; H04N 25/57; H04N 25/78; H04N 23/71; H04N 23/73

(57) ABSTRACT

A sensor device comprises a plurality of pixels each configured to receive light and perform photoelectric conversion to generate an electrical signal, circuitry that is configured to generate event data by detecting as events intensity changes above a predetermined threshold of the light received by each of event detecting pixels that form a first subset of the pixels, generate for each of a series of frame periods pixel signals constituting a frame image that indicates intensity values of the light received by each of intensity detecting pixels that form a second subset of the pixels during respective exposure periods, and associate with each other event detecting pixels and intensity detecting pixels that have a corresponding field of view and to dynamically change the exposure periods of the intensity detecting pixels based on the events detected by the associated event detecting pixels.

### FIELD OF THE INVENTION

The present technology relates to a sensor device and a method for operating a sensor device, in particular, to a sensor device and a method for operating a sensor device that allows capturing images with reduced motion blur and/or improved dynamic range.

### BACKGROUND

Conventional image sensors like active pixel sensors, APS, capture images and/or videos of a scene by collecting light on photoelectric conversion elements of pixels arranged in a pixel array during an exposure period, and by reading out at the end of the exposure period an electrical signal corresponding to the intensity of the light received during the exposure period. Readout may e.g. be performed by reading out all rows of the pixel array in parallel (global shutter) or by reading out different rows with a time shift between readout starting times (rolling shutter). A single readout of all pixels in the pixel array will produce one image frame. Since frames are generated consecutively, the temporal resolution of conventional image sensors is determined by the frame rate of the image sensor, i.e. the number of frames that is generated per unit time. The temporal resolution will be constituted approximately by the frame period, i.e. the period necessary to generate one image frame.

It is a well-known problem in such conventional image sensors that motions having a smaller time constant than the frame period will lead to motion blur in the image frames. This problem is even worsened, if one aims to generate image frames having a high dynamic range, HDR, since usually several image frames captured with different exposure periods are combined to form a single HDR image.

In contrast dynamic/event-based vision sensors, DVS/EVS, detect intensity changes pixel by pixel and may be operated asynchronously. Since capturing and/or processing of unchanged, and hence redundant, information is avoided, data rates of EVS are typically smaller than data rates of APS. This means that EVS can have a much higher time resolution than APS. Further, since only changes in intensity are detected, EVS have intrinsically a high dynamic range. However, EVS data do not allow reproduction of color or grayscale images that resemble the world as perceived by a human. So, images generated solely by EVSs miss information that is required for a human to qualify an image as a true image of the real world.

It is therefore desirable to combine the advantages of conventional image sensors, like APS, with the advantages of DVS/EVS, in particular in order to generate image frames with high dynamic range and/or reduced motion blur.

### SUMMARY OF INVENTION

To this end, a sensor device is provided that comprises a plurality of pixels each configured to receive light and perform photoelectric conversion to generate an electrical signal, event detection circuitry that is configured to generate event data by detecting as events intensity changes above a predetermined threshold of the light received by each of event detecting pixels that form a first subset of the pixels, pixel signal generating circuitry that is configured to generate for each of a series of frame periods pixel signals constituting a frame image that indicates intensity values of the light received by each of intensity detecting pixels that form a second subset of the pixels during respective exposure periods, and a control unit. Here, the control unit is configured to associate with each other event detecting pixels and intensity detecting pixels that have a corresponding field of view and to dynamically change the exposure periods of the intensity detecting pixels based on the events detected by the associated event detecting pixels.

Further a method for operating a sensor device is provided that comprises: receiving light and performing photoelectric conversion with each of a plurality of pixels of the sensor device to generate an electrical signal; generating, with event detection circuitry of the sensor device, event data by detecting as events intensity changes above a predetermined threshold of the light received by each of event detecting pixels that form a first subset of the pixels; generating, with pixel signal generating circuitry, for each of a series of frame periods pixel signals constituting a frame image that indicates intensity values of the light received by each of intensity detecting pixels that form a second subset of the pixels during respective exposure periods; associating with each other event detecting pixels and intensity detecting pixels that have a corresponding field of view; and dynamically changing the exposure periods of the intensity detecting pixels based on the events detected by the associated event detecting pixels.

Thus, a combination of event detecting pixels operating as an EVS and of intensity detecting pixels operating as an APS is provided. The intensity detecting pixels operate in principal in a conventional manner in that frame images are generated with a given frame rate, defined by the frame period that is necessary to generate a frame image. Here, the intensity detecting pixels receive light that produces the signal to be read out only during exposure periods that are equal to or smaller than the frame period. The exposure period of each intensity detecting pixel determines on the one hand the sensitivity of this pixel: the longer the exposure period the more light can be received. On the other hand will the amount of motion blur occurring in each frame image also be dictated by the exposure period, basically for the same reason: if a moving object is capable to travel during the exposure period by more than the spatial resolution of the intensity detecting pixels, then motion blur will occur.

Thus, in order to reduce motion blur and/or in order to adapt the sensitivity of the intensity detecting pixels to the brightness range observable by each pixel, the control unit is configured to change dynamically, i.e. during each frame period, the exposure periods of the intensity detecting pixels.

The measure to determine how much change is necessary, respectively to determine which value to set for the exposure periods are the events detected by the event detecting pixels. As the detected events represent on the one hand the motion within the scene (the more motion, the more events) and allows on the other hand also an estimation about the observed brightness (the more change in brightness, the more events), the events give a representation of the parameters that are to be controlled via an adjustment of the exposure periods. Further, since the latency of event detection is much smaller than the latency of image frame generation, it is possible to adjust also the exposure periods with low latency, which leads to a quick reduction of motion blur/a quick adaption of the sensitivity.

In this manner it is possible to use the advantages of EVS data to generate improved APS image frames, in particular APS images and/or frames with reduced motion blur.

### BRIEF DESCRIPTION OF DRAWINGS

FIG. 1 is a schematic diagram of a sensor device.

FIG. 2 is a schematic block diagram of a sensor section.

FIG. 3 is a schematic block diagram of a pixel array section.

FIG. 4 is a schematic circuit diagram of a pixel block.

FIG. 5 is a schematic block diagram illustrating of an event detecting section.

FIG. 6 is a schematic circuit diagram of a current-voltage converting section.

FIG. 7 is a schematic circuit diagram of a subtraction section and a quantization section.

FIG. 8 is a schematic diagram of a frame data generation method based on event data.

FIG. 9 is a schematic block diagram of another quantization section.

FIG. 10 is a schematic diagram of another event detecting section.

FIG. 11 is a schematic block diagram of another pixel array section.

FIG. 12 is a schematic circuit diagram of another pixel block.

FIG. 13 is a schematic block diagram of a scan-type sensor device.

FIG. 14 is a schematic block diagram of a sensor device and its function.

FIGS. 15A to 15E are schematic block diagrams showing distributions of pixels with different functions.

FIG. 16 shows schematic examples for event counting.

FIG. 17 shows a schematic block diagram of a sensor device and its function.

FIG. 18 shows schematic block diagrams showing distributions of pixels with different functions and their application.

FIG. 19 shows a schematic block diagram showing a distribution of pixels with different functions and their application.

FIG. 20 shows a schematic time flow of a pixel exposure and readout process.

FIG. 21 shows a schematic block diagram of a sensor device.

FIG. 22 shows schematic examples for the assignment of exposure periods across a pixel array.

FIG. 23 shows schematic time flows of pixel exposure and readout processes.

FIG. 24 shows a schematic process flow of a pixel exposure and readout process.

FIG. 25 shows a schematic time flow of a pixel exposure and readout process.

FIG. 26 shows a schematic time flow of a pixel exposure and readout process.

FIG. 27 shows a schematic process flow of a pixel exposure and readout process.

FIG. 28 shows a schematic time flow of a pixel exposure and readout process.

FIG. 29 shows schematically an adjustment of pixel intensities to a predetermined range based on exposure control.

FIG. 30 illustrates schematically a process flow of a method for operating a sensor device

FIG. 31 is a schematic block diagram of a vehicle control system.

FIG. 32 is a diagram of assistance in explaining an example of installation positions of an outside-vehicle information detecting section and an imaging section.

### DETAILED DESCRIPTION

The present disclosure is directed to improvements of images/image frames obtainable via APS-like sensors, by using sensors with mixed APS and EVS pixels. In particular, the problem is addressed how to adjust exposure periods or APS pixels such as to reduce motion blur and/or to obtain a high dynamic range. The solutions to this problem discussed below are applicable to all according sensor types. However, in order to ease the description and also in order to cover an important application example, the present description is focused without prejudice on hybrid sensors that combine APS pixels with EVS pixels.

First, a possible implementation of a hybrid APS+DVS/EVS will be described. This is of course purely exemplary. It is to be understood that the hybrid sensor could also be implemented differently.

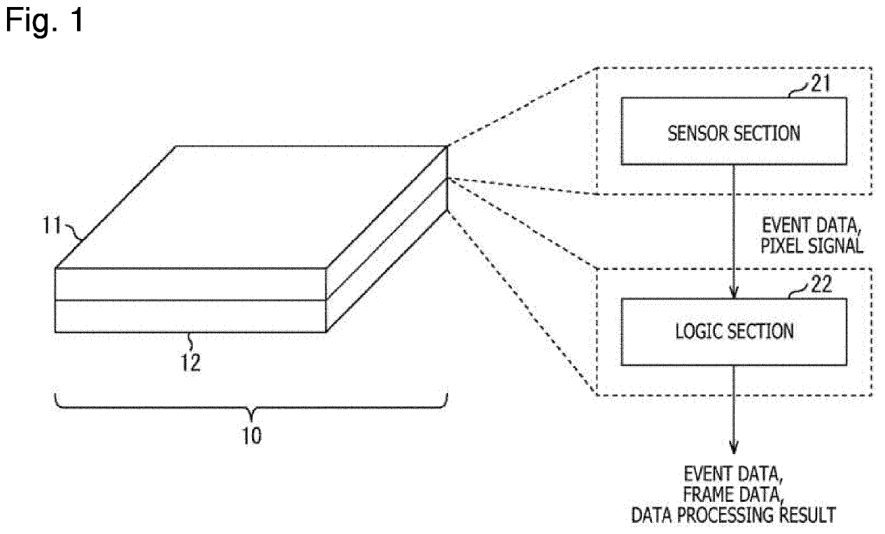

FIG. 1 is a diagram illustrating a configuration example of a sensor device 10, which is in the example of FIG. 1 constituted by a sensor chip.

The sensor device 10 is a single-chip semiconductor chip and includes a sensor die (substrate) 11, which serves as a plurality of dies (substrates), and a logic die 12 that are stacked. Note that, the sensor device 10 can also include only a single die or three or more stacked dies.

In the sensor device 10 of FIG. 1, the sensor die 11 includes (a circuit serving as) a sensor section 21, and the logic die 12 includes a logic section 22. Note that, the sensor section 21 can be partly formed on the logic die 12. Further, the logic section 22 can be partly formed on the sensor die 11.

The sensor section 21 includes pixels configured to perform photoelectric conversion on incident light to generate electrical signals, and generates event data indicating the occurrence of events that are changes in the electrical signal of the pixels. The sensor section 21 supplies the event data to the logic section 22. That is, the sensor section 21 performs imaging of performing, in the pixels, photoelectric conversion on incident light to generate electrical signals, similarly to a synchronous image sensor, for example. The sensor section 21, however, generates event data indicating the occurrence of events that are changes in the electrical signal of the pixels instead of generating image data in a frame format (frame data). The sensor section 21 outputs, to the logic section 22, the event data obtained by the imaging.

Here, the synchronous image sensor is an image sensor configured to perform imaging in synchronization with a vertical synchronization signal and output frame data that is image data in a frame format. The sensor section 21 can be regarded as asynchronous (an asynchronous image sensor) in contrast to the synchronous image sensor, since the sensor section 21 does not operate in synchronization with a vertical synchronization signal when outputting event data.

Note that, the sensor section 21 can generate and output, other than event data, frame data, similarly to the synchronous image sensor. In addition, the sensor section 21 can output, together with event data, electrical signals of pixels in which events have occurred, as pixel signals that are pixel values of the pixels in frame data.

The logic section 22 controls the sensor section 21 as needed. Further, the logic section 22 performs various types of data processing, such as data processing of generating frame data on the basis of event data from the sensor section 21 and image processing on frame data from the sensor section 21 or frame data generated on the basis of the event data from the sensor section 21, and outputs data processing results obtained by performing the various types of data processing on the event data and the frame data.

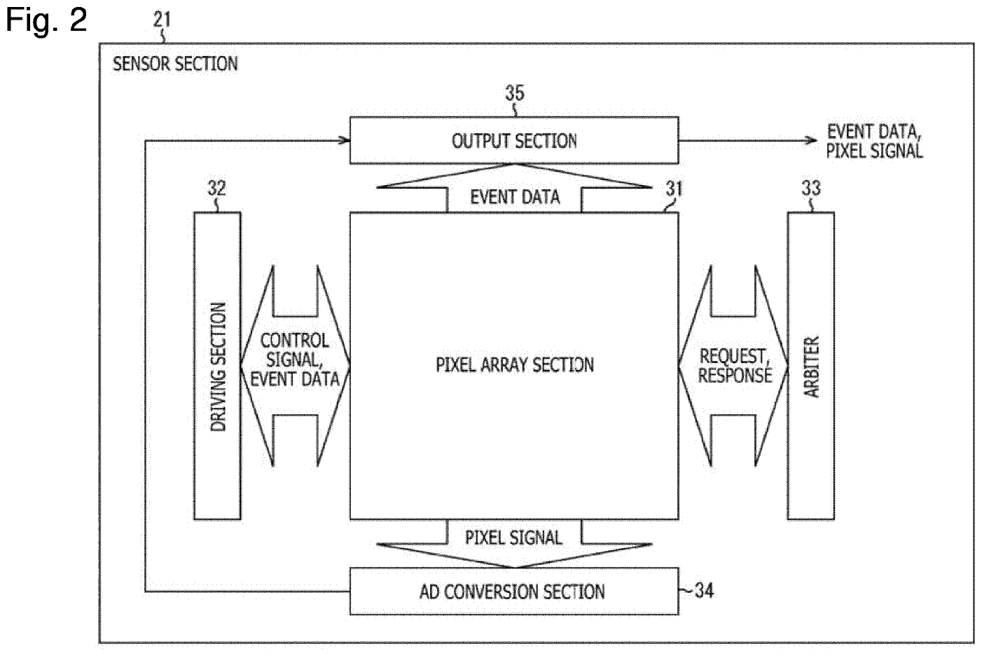

FIG. 2 is a block diagram illustrating a configuration example of the sensor section 21 of FIG. 1.

The sensor section 21 includes a pixel array section 31, a driving section 32, an arbiter 33, an AD (Analog to Digital) conversion section 34, and an output section 35.

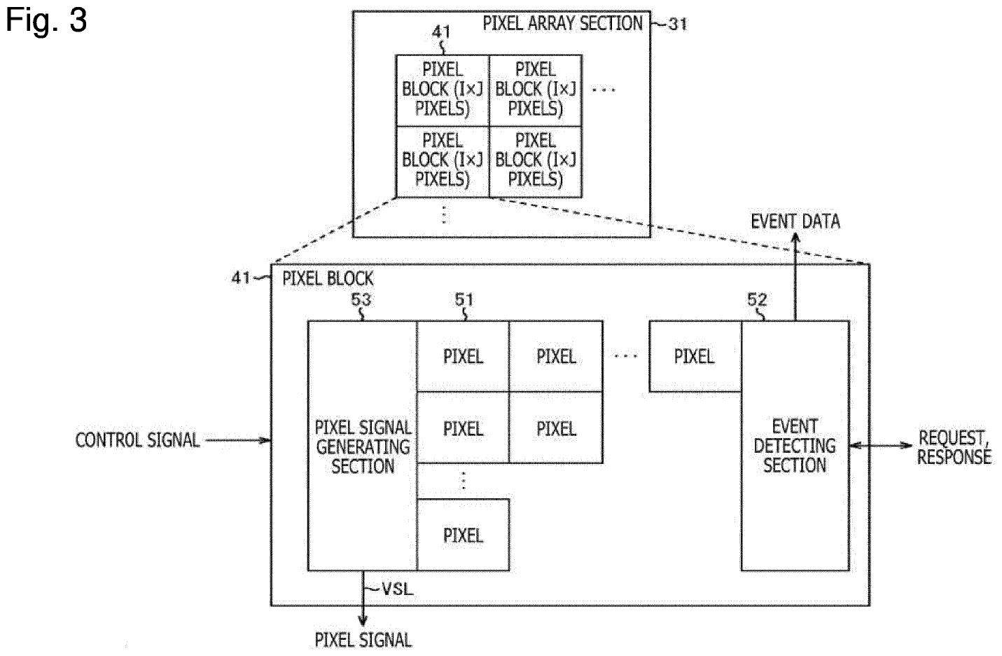

The pixel array section 31 includes a plurality of pixels 51 (FIG. 3) arrayed in a two-dimensional lattice pattern. The pixel array section 31 detects, in a case where a change larger than a predetermined threshold (including a change equal to or larger than the threshold as needed) has occurred in (a voltage corresponding to) a photocurrent that is an electrical signal generated by photoelectric conversion in the pixel 51, the change in the photocurrent as an event. In a case of detecting an event, the pixel array section 31 outputs, to the arbiter 33, a request for requesting the output of event data indicating the occurrence of the event. Then, in a case of receiving a response indicating event data output permission from the arbiter 33, the pixel array section 31 outputs the event data to the driving section 32 and the output section 35. In addition, the pixel array section 31 may output an electrical signal of the pixel 51 in which the event has been detected to the AD conversion section 34, as a pixel signal. Preferably, the pixel array section 31 may output pixel signals based on a rolling shutter approach.

The driving section 32 supplies control signals to the pixel array section 31 to drive the pixel array section 31. For example, the driving section 32 drives the pixel 51 regarding which the pixel array section 31 has output event data, so that the pixel 51 in question supplies (outputs) a pixel signal to the AD conversion section 34. However, preferably the driving section 32 drives the pixels 51 by applying a rolling shutter that starts readout of the pixel signals of adjacent pixel rows at times separated by a predetermined time period.

The arbiter 33 arbitrates the requests for requesting the output of event data from the pixel array section 31, and returns responses indicating event data output permission or prohibition to the pixel array section 31.

The AD conversion section 34 includes, for example, a single-slope ADC (AD converter) (not illustrated) in each column of pixel blocks 41 (FIG. 3) described later, for example. The AD conversion section 34 performs, with the ADC in each column, AD conversion on pixel signals of the pixels 51 of the pixel blocks 41 in the column, and supplies the resultant to the output section 35. Note that, the AD conversion section 34 can perform CDS (Correlated Double Sampling) together with pixel signal AD conversion.

The output section 35 performs necessary processing on the pixel signals from the AD conversion section 34 and the event data from the pixel array section 31 and supplies the resultant to the logic section 22 (FIG. 1).

Here, a change in the photocurrent generated in the pixel 51 can be recognized as a change in the amount of light entering the pixel 51, so that it can also be said that an event is a change in light amount (a change in light amount larger than the threshold) in the pixel 51.

Event data indicating the occurrence of an event at least includes location information (coordinates or the like) indicating the location of a pixel block in which a change in light amount, which is the event, has occurred. Besides, the event data can also include the polarity (positive or negative) of the change in light amount.

With regard to the series of event data that is output from the pixel array section 31 at timings at which events have occurred, it can be said that, as long as the event data interval is the same as the event occurrence interval, the event data implicitly includes time point information indicating (relative) time points at which the events have occurred. However, for example, when the event data is stored in a memory and the event data interval is no longer the same as the event occurrence interval, the time point information implicitly included in the event data is lost. Thus, the output section 35 includes, in event data, time point information indicating (relative) time points at which events have occurred, such as timestamps, before the event data interval is changed from the event occurrence interval. The processing of including time point information in event data can be performed in any block other than the output section 35 as long as the processing is performed before time point information implicitly included in event data is lost. Further, events may be read out at predetermined time points such as to generate the event data in a frame-like fashion.

FIG. 3 is a block diagram illustrating a configuration example of the pixel array section 31 of FIG. 2.

The pixel array section 31 includes the plurality of pixel blocks 41. The pixel block 41 includes the I×J pixels 51 that are one or more pixels arrayed in I rows and J columns (I and J are integers), an event detecting section 52, and a pixel signal generating section 53. The one or more pixels 51 in the pixel block 41 share the event detecting section 52 and the pixel signal generating section 53. Further, in each column of the pixel blocks 41, a VSL (Vertical Signal Line) for connecting the pixel blocks 41 to the ADC of the AD conversion section 34 is wired.

The pixel 51 receives light incident from an object and performs photoelectric conversion to generate a photocurrent serving as an electrical signal. The pixel 51 supplies the photocurrent to the event detecting section 52 under the control of the driving section 32.

The event detecting section 52 detects, as an event, a change larger than the predetermined threshold in photocurrent from each of the pixels 51, under the control of the driving section 32. In a case of detecting an event, the event detecting section 52 supplies, to the arbiter 33 (FIG. 2), a request for requesting the output of event data indicating the occurrence of the event. Then, when receiving a response indicating event data output permission to the request from the arbiter 33, the event detecting section 52 outputs the event data to the driving section 32 and the output section 35.

The pixel signal generating section 53 may generate, in the case where the event detecting section 52 has detected an event, a voltage corresponding to a photocurrent from the pixel 51 as a pixel signal, and supplies the voltage to the AD conversion section 34 through the VSL, under the control of the driving section 32. The pixel signal generating section 53 may generate pixel signals also based on various other triggers, e.g. based on a temporally shifted selection of readout rows, i.e. by applying a rolling shutter.

Here, detecting a change larger than the predetermined threshold in photocurrent as an event can also be recognized as detecting, as an event, absence of change larger than the predetermined threshold in photocurrent. The pixel signal generating section 53 can generate a pixel signal in the case where absence of change larger than the predetermined threshold in photocurrent has been detected as an event as well as in the case where a change larger than the predetermined threshold in photocurrent has been detected as an event.

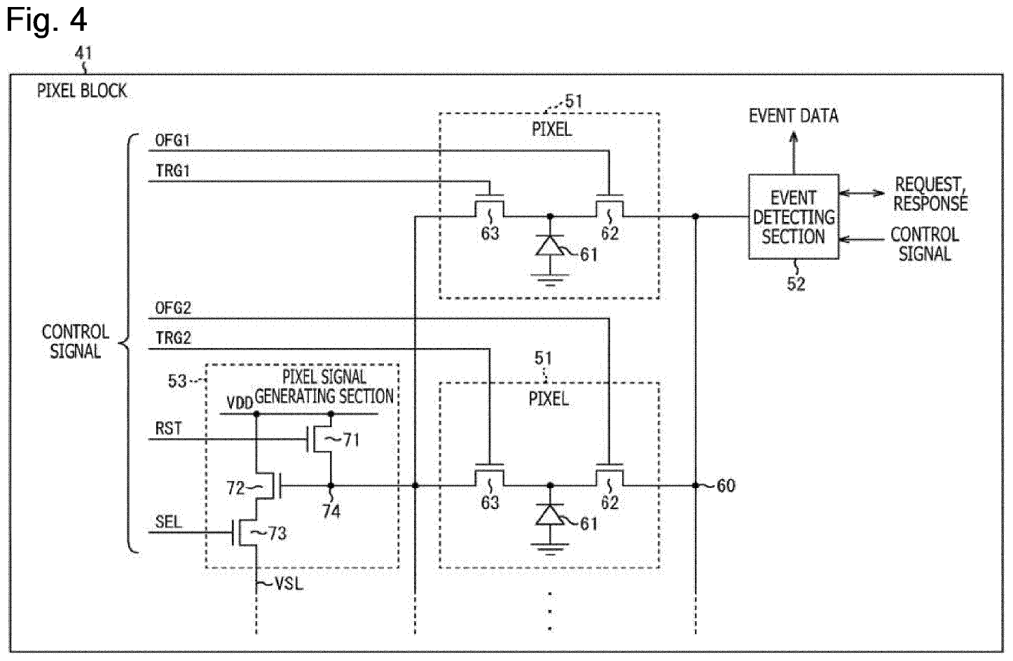

FIG. 4 is a circuit diagram illustrating a configuration example of the pixel block 41.

The pixel block 41 includes, as described with reference to FIG. 3, the pixels 51, the event detecting section 52, and the pixel signal generating section 53.

The pixel 51 includes a photoelectric conversion element 61 and transfer transistors 62 and 63.

The photoelectric conversion element 61 includes, for example, a PD (Photodiode). The photoelectric conversion element 61 receives incident light and performs photoelectric conversion to generate charges.

The transfer transistor 62 includes, for example, an N (Negative)-type MOS (Metal-Oxide-Semiconductor) FET (Field Effect Transistor). The transfer transistor 62 of the n-th pixel 51 of the I×J pixels 51 in the pixel block 41 is turned on or off in response to a control signal OFGn supplied from the driving section 32 (FIG. 2). When the transfer transistor 62 is turned on, charges generated in the photoelectric conversion element 61 are transferred (supplied) to the event detecting section 52, as a photocurrent.

The transfer transistor 63 includes, for example, an N-type MOSFET. The transfer transistor 63 of the n-th pixel 51 of the I×J pixels 51 in the pixel block 41 is turned on or off in response to a control signal TRGn supplied from the driving section 32. When the transfer transistor 63 is turned on, charges generated in the photoelectric conversion element 61 are transferred to an FD 74 of the pixel signal generating section 53.

The I×J pixels 51 in the pixel block 41 are connected to the event detecting section 52 of the pixel block 41 through nodes 60. Thus, photocurrents generated in (the photoelectric conversion elements 61 of) the pixels 51 are supplied to the event detecting section 52 through the nodes 60. As a result, the event detecting section 52 receives the sum of photocurrents from all the pixels 51 in the pixel block 41. Thus, the event detecting section 52 detects, as an event, a change in sum of photocurrents supplied from the I×J pixels 51 in the pixel block 41.

The pixel signal generating section 53 includes a reset transistor 71, an amplification transistor 72, a selection transistor 73, and the FD (Floating Diffusion) 74.

The reset transistor 71, the amplification transistor 72, and the selection transistor 73 include, for example, N-type MOSFETs.

The reset transistor 71 is turned on or off in response to a control signal RST supplied from the driving section 32 (FIG. 2). When the reset transistor 71 is turned on, the FD 74 is connected to a power supply VDD, and charges accumulated in the FD 74 are thus discharged to the power supply VDD. With this, the FD 74 is reset.

The amplification transistor 72 has a gate connected to the FD 74, a drain connected to the power supply VDD, and a source connected to the VSL through the selection transistor 73. The amplification transistor 72 is a source follower and outputs a voltage (electrical signal) corresponding to the voltage of the FD 74 supplied to the gate to the VSL through the selection transistor 73.

The selection transistor 73 is turned on or off in response to a control signal SEL supplied from the driving section 32. When the selection transistor 73 is turned on, a voltage corresponding to the voltage of the FD 74 from the amplification transistor 72 is output to the VSL.

The FD 74 accumulates charges transferred from the photoelectric conversion elements 61 of the pixels 51 through the transfer transistors 63, and converts the charges to voltages.

With regard to the pixels 51 and the pixel signal generating section 53, which are configured as described above, the driving section 32 turns on the transfer transistors 62 with control signals OFGn, so that the transfer transistors 62 supply, to the event detecting section 52, photocurrents based on charges generated in the photoelectric conversion elements 61 of the pixels 51. With this, the event detecting section 52 receives a current that is the sum of the photocurrents from all the pixels 51 in the pixel block 41, which might also be only a single pixel.

According to a possible operation mode, when the event detecting section 52 detects, as an event, a change in photocurrent (sum of photocurrents) in the pixel block 41, the driving section 32 turns off the transfer transistors 62 of all the pixels 51 in the pixel block 41, to thereby stop the supply of the photocurrents to the event detecting section 52. Then, the driving section 32 sequentially turns on, with the control signals TRGn, the transfer transistors 63 of the pixels 51 in the pixel block 41 in which the event has been detected, so that the transfer transistors 63 transfers charges generated in the photoelectric conversion elements 61 to the FD 74. The FD 74 accumulates the charges transferred from (the photoelectric conversion elements 61 of) the pixels 51. Voltages corresponding to the charges accumulated in the FD 74 are output to the VSL, as pixel signals of the pixels 51, through the amplification transistor 72 and the selection transistor 73.

Alternatively, the transfer transistors 62, 63 may be used to switch the function of the pixel from event detection to pixel signal generation in a temporally predefined manner in order to provide a pixel 51 with time multiplexed function.

As described above, in the sensor section 21 (FIG. 2), only pixel signals of the pixels 51 in the pixel block 41 in which an event has been detected may be sequentially output to the VSL. The pixel signals output to the VSL are supplied to the AD conversion section 34 to be subjected to AD conversion. Preferably, pixel signal readout is independent of event detection and pixel signal selection via the selection transistor 73 follows the concepts of a global or rolling shutter.

Here, in the pixels 51 in the pixel block 41, the transfer transistors 63 can be turned on not sequentially but simultaneously. In this case, the sum of pixel signals of all the pixels 51 in the pixel block 41 can be output.

In the pixel array section 31 of FIG. 3, the pixel block 41 includes one or more pixels 51, and the one or more pixels 51 share the event detecting section 52 and the pixel signal generating section 53. Thus, in the case where the pixel block 41 includes a plurality of pixels 51, the numbers of the event detecting sections 52 and the pixel signal generating sections 53 can be reduced as compared to a case where the event detecting section 52 and the pixel signal generating section 53 are provided for each of the pixels 51, with the result that the scale of the pixel array section 31 can be reduced.

Note that, in the case where the pixel block 41 includes a plurality of pixels 51, the event detecting section 52 can be provided for each of the pixels 51. In the case where the plurality of pixels 51 in the pixel block 41 share the event detecting section 52, events are detected in units of the pixel blocks 41. In the case where the event detecting section 52 is provided for each of the pixels 51, however, events can be detected in units of the pixels 51.

Yet, even in the case where the plurality of pixels 51 in the pixel block 41 share the single event detecting section 52, events can be detected in units of the pixels 51 when the transfer transistors 62 of the plurality of pixels 51 are temporarily turned on in a time-division manner.

Further, in a case where there is no need to output pixel signals, e.g. since pixel signals are generated by a separate pixel array or a separate sensor device, the pixel block 41 can be formed without the pixel signal generating section 53. In the case where the pixel block 41 is formed without the pixel signal generating section 53, the sensor section 21 can be formed without the AD conversion section 34 and the transfer transistors 63. In this case, the scale of the sensor section 21 can be reduced. The sensor will then output the address of the pixel (block) in which the event occurred, if necessary with a time stamp.

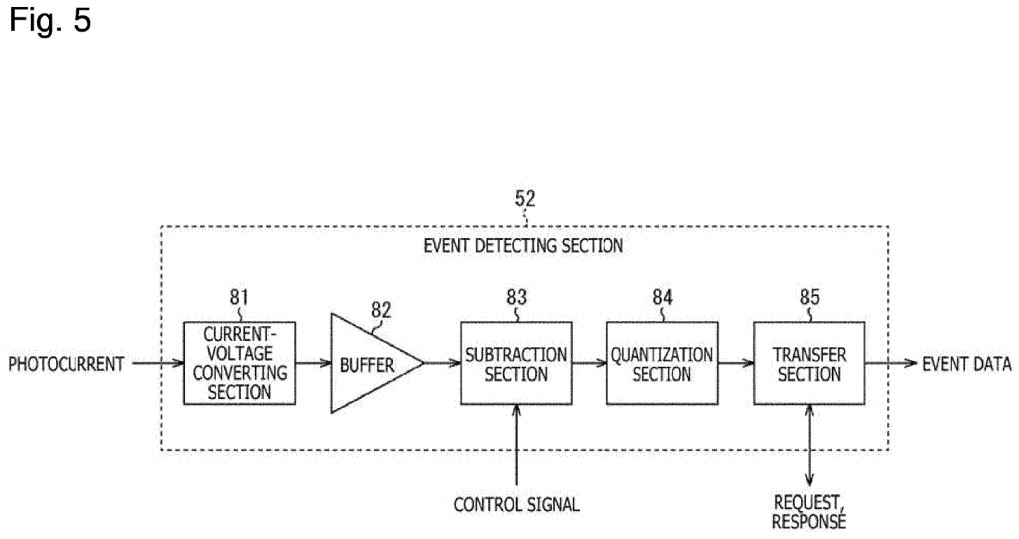

FIG. 5 is a block diagram illustrating a configuration example of the event detecting section 52 of FIG. 3.

The event detecting section 52 includes a current-voltage converting section 81, a buffer 82, a subtraction section 83, a quantization section 84, and a transfer section 85.

The current-voltage converting section 81 converts (a sum of) photocurrents from the pixels 51 to voltages corresponding to the logarithms of the photocurrents (hereinafter also referred to as a “photovoltage”) and supplies the voltages to the buffer 82.

The buffer 82 buffers photovoltages from the current-voltage converting section 81 and supplies the resultant to the subtraction section 83.

The subtraction section 83 calculates, at a timing instructed by a row driving signal that is a control signal from the driving section 32, a difference between the current photovoltage and a photovoltage at a timing slightly shifted from the current time, and supplies a difference signal corresponding to the difference to the quantization section 84.

The quantization section 84 quantizes difference signals from the subtraction section 83 to digital signals and supplies the quantized values of the difference signals to the transfer section 85 as event data.

The transfer section 85 transfers (outputs), on the basis of event data from the quantization section 84, the event data to the output section 35. That is, the transfer section 85 supplies a request for requesting the output of the event data to the arbiter 33. Then, when receiving a response indicating event data output permission to the request from the arbiter 33, the transfer section 85 outputs the event data to the output section 35.

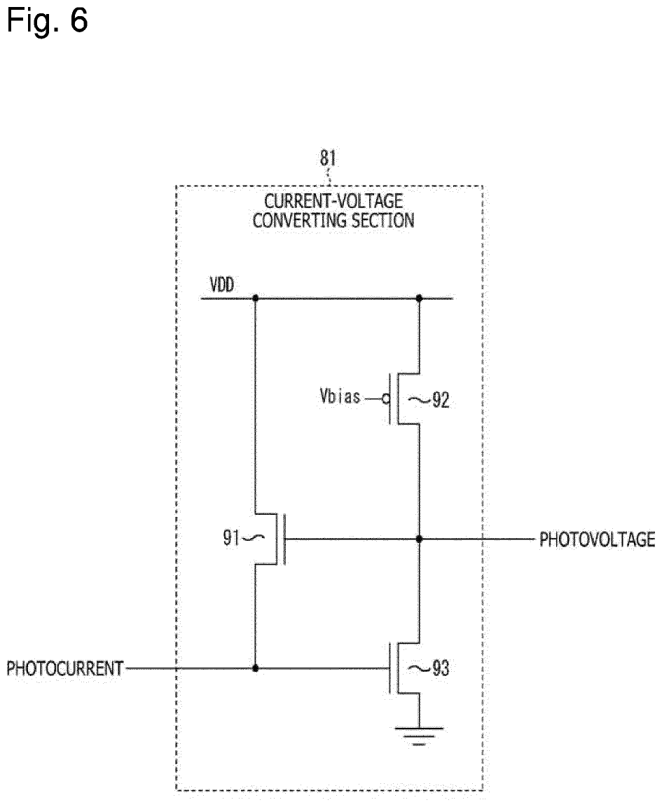

FIG. 6 is a circuit diagram illustrating a configuration example of the current-voltage converting section 81 of FIG. 5.

The current-voltage converting section 81 includes transistors 91 to 93. As the transistors 91 and 93, for example, N-type MOSFETs can be employed. As the transistor 92, for example, a P-type MOSFET can be employed.

The transistor 91 has a source connected to the gate of the transistor 93, and a photocurrent is supplied from the pixel 51 to the connecting point between the source of the transistor 91 and the gate of the transistor 93. The transistor 91 has a drain connected to the power supply VDD and a gate connected to the drain of the transistor 93.

The transistor 92 has a source connected to the power supply VDD and a drain connected to the connecting point between the gate of the transistor 91 and the drain of the transistor 93. A predetermined bias voltage Vbias is applied to the gate of the transistor 92. With the bias voltage Vbias, the transistor 92 is turned on or off, and the operation of the current-voltage converting section 81 is turned on or off depending on whether the transistor 92 is turned on or off.

The source of the transistor 93 is grounded.

In the current-voltage converting section 81, the transistor 91 has the drain connected on the power supply VDD side. The source of the transistor 91 is connected to the pixels 51 (FIG. 4), so that photocurrents based on charges generated in the photoelectric conversion elements 61 of the pixels 51 flow through the transistor 91 (from the drain to the source). The transistor 91 operates in a subthreshold region, and at the gate of the transistor 91, photovoltages corresponding to the logarithms of the photocurrents flowing through the transistor 91 are generated. As described above, in the current-voltage converting section 81, the transistor 91 converts photocurrents from the pixels 51 to photovoltages corresponding to the logarithms of the photocurrents.

In the current-voltage converting section 81, the transistor 91 has the gate connected to the connecting point between the drain of the transistor 92 and the drain of the transistor 93, and the photovoltages are output from the connecting point in question.

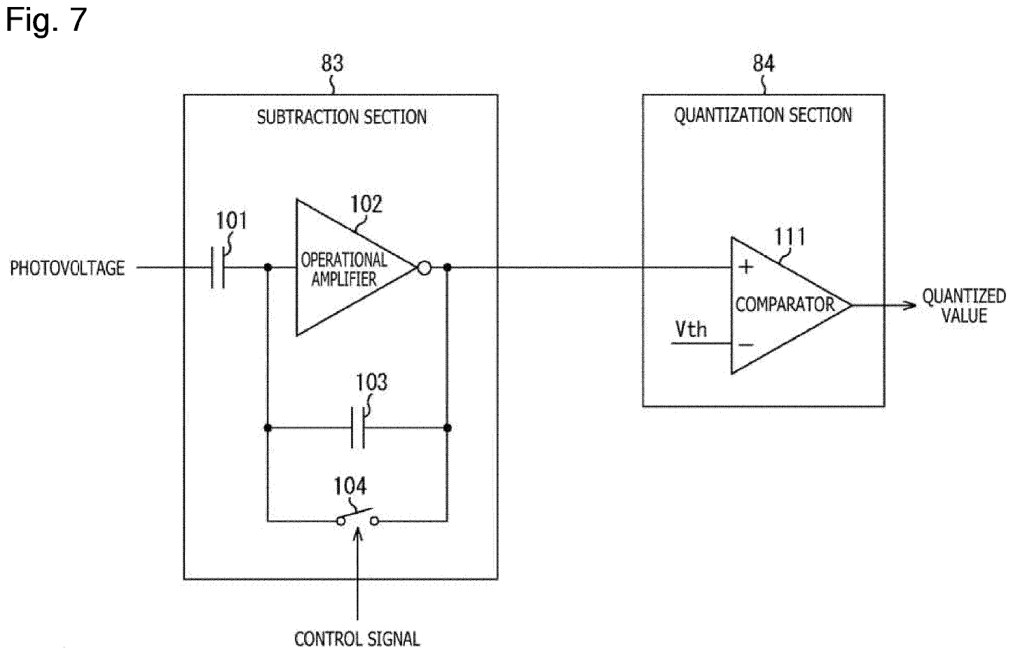

FIG. 7 is a circuit diagram illustrating configuration examples of the subtraction section 83 and the quantization section 84 of FIG. 5.

The subtraction section 83 includes a capacitor 101, an operational amplifier 102, a capacitor 103, and a switch 104. The quantization section 84 includes a comparator 111.

The capacitor 101 has one end connected to the output terminal of the buffer 82 (FIG. 5) and the other end connected to the input terminal (inverting input terminal) of the operational amplifier 102. Thus, photovoltages are input to the input terminal of the operational amplifier 102 through the capacitor 101.

The operational amplifier 102 has an output terminal connected to the non-inverting input terminal (+) of the comparator 111.

The capacitor 103 has one end connected to the input terminal of the operational amplifier 102 and the other end connected to the output terminal of the operational amplifier 102.

The switch 104 is connected to the capacitor 103 to switch the connections between the ends of the capacitor 103. The switch 104 is turned on or off in response to a row driving signal that is a control signal from the driving section 32, to thereby switch the connections between the ends of the capacitor 103.

A photovoltage on the buffer 82 (FIG. 5) side of the capacitor 101 when the switch 104 is on is denoted by Vinit, and the capacitance (electrostatic capacitance) of the capacitor 101 is denoted by C1. The input terminal of the operational amplifier 102 serves as a virtual ground terminal, and a charge Qinit that is accumulated in the capacitor 101 in the case where the switch 104 is on is expressed by Expression (1).

$$Qinit = C 1 \times Vinit \qquad ( 1 )$$

Further, in the case where the switch 104 is on, the connection between the ends of the capacitor 103 is cut (short-circuited), so that no charge is accumulated in the capacitor 103.

When a photovoltage on the buffer 82 (FIG. 5) side of the capacitor 101 in the case where the switch 104 has thereafter been turned off is denoted by Vafter, a charge Qafter that is accumulated in the capacitor 101 in the case where the switch 104 is off is expressed by Expression (2).

$$Qafter = C 1 \times Vafter \qquad ( 2 )$$

When the capacitance of the capacitor 103 is denoted by C2 and the output voltage of the operational amplifier 102 is denoted by Vout, a charge Q2 that is accumulated in the capacitor 103 is expressed by Expression (3).

$$Q 2 = - C 2 \times Vout \qquad ( 3 )$$

Since the total amount of charges in the capacitors 101 and 103 does not change before and after the switch 104 is turned off, Expression (4) is established.

$$Qinit = Qafter + Q 2 \qquad ( 4 )$$

When Expression (1) to Expression (3) are substituted for Expression (4), Expression (5) is obtained.

$$Vout = - ( C 1 / C 2 ) \times ( Vafter - Vinit ) \qquad ( 5 )$$

With Expression (5), the subtraction section 83 subtracts the photovoltage Vinit from the photovoltage Vafter, that is, calculates the difference signal (Vout) corresponding to a difference Vafter−Vinit between the photovoltages Vafter and Vinit. With Expression (5), the subtraction gain of the subtraction section 83 is C1/C2. Since the maximum gain is normally desired, C1 is preferably set to a large value and C2 is preferably set to a small value. Meanwhile, when C2 is too small, kTC noise increases, resulting in a risk of deteriorated noise characteristics. Thus, the capacitance C2 can only be reduced in a range that achieves acceptable noise. Further, since the pixel blocks 41 each have installed therein the event detecting section 52 including the subtraction section 83, the capacitances C1 and C2 have space constraints. In consideration of these matters, the values of the capacitances C1 and C2 are determined.

The comparator 111 compares a difference signal from the subtraction section 83 with a predetermined threshold (voltage) Vth (>0) applied to the inverting input terminal (−), thereby quantizing the difference signal. The comparator 111 outputs the quantized value obtained by the quantization to the transfer section 85 as event data.

For example, in a case where a difference signal is larger than the threshold Vth, the comparator 111 outputs an H (High) level indicating 1, as event data indicating the occurrence of an event. In a case where a difference signal is not larger than the threshold Vth, the comparator 111 outputs an L (Low) level indicating 0, as event data indicating that no event has occurred.

The transfer section 85 supplies a request to the arbiter 33 in a case where it is confirmed on the basis of event data from the quantization section 84 that a change in light amount that is an event has occurred, that is, in the case where the difference signal (Vout) is larger than the threshold Vth. When receiving a response indicating event data output permission, the transfer section 85 outputs the event data indicating the occurrence of the event (for example, H level) to the output section 35.

The output section 35 includes, in event data from the transfer section 85, location/address information regarding (the pixel block 41 including) the pixel 51 in which an event indicated by the event data has occurred and time point information indicating a time point at which the event has occurred, and further, as needed, the polarity of a change in light amount that is the event, i.e. whether the intensity did increase or decrease. The output section 35 outputs the event data.

As the data format of event data including location information regarding the pixel 51 in which an event has occurred, time point information indicating a time point at which the event has occurred, and the polarity of a change in light amount that is the event, for example, the data format called “AER (Address Event Representation)” can be employed.

Note that, a gain A of the entire event detecting section 52 is expressed by the following expression where the gain of the current-voltage converting section 81 is denoted by CG_{log} and the gain of the buffer 82 is 1.

$$A = C {G}_{log} C 1 / C 2 ( \sum {i}_{p h oto} \_n ) \qquad ( 6 )$$

Here, iₚₕₒₜₒ_n denotes a photocurrent of the n-th pixel 51 of the I×J pixels 51 in the pixel block 41. In Expression (6), Σ denotes the summation of n that takes integers ranging from 1 to I×J.

Note that, the pixel 51 can receive any light as incident light with an optical filter through which predetermined light passes, such as a color filter. For example, in a case where the pixel 51 receives visible light as incident light, event data indicates the occurrence of changes in pixel value in images including visible objects. Further, for example, in a case where the pixel 51 receives, as incident light, infrared light, millimeter waves, or the like for ranging, event data indicates the occurrence of changes in distances to objects. In addition, for example, in a case where the pixel 51 receives infrared light for temperature measurement, as incident light, event data indicates the occurrence of changes in temperature of objects. In the present embodiment, the pixel 51 is assumed to receive visible light as incident light.

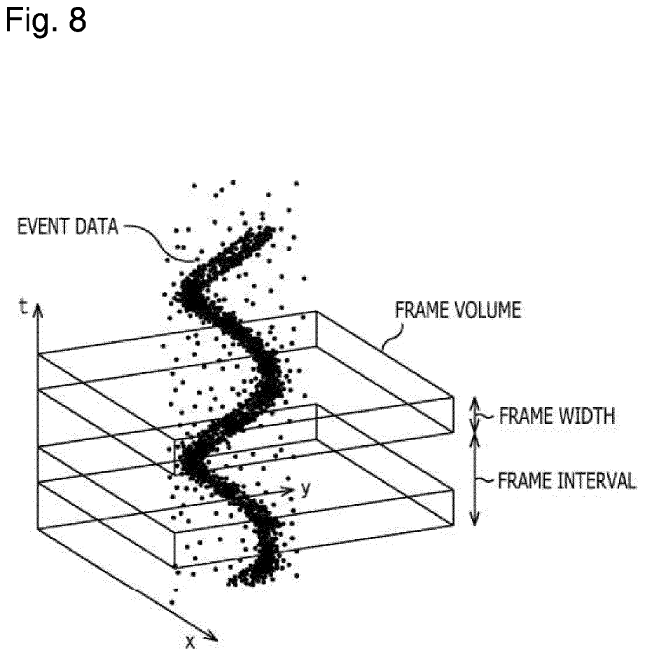

FIG. 8 is a diagram illustrating an example of a frame data generation method based on event data.

The logic section 22 sets a frame interval and a frame width on the basis of an externally input command, for example. Here, the frame interval represents the interval of frames of frame data that is generated on the basis of event data. The frame width represents the time width of event data that is used for generating frame data on a single frame. A frame interval and a frame width that are set by the logic section 22 are also referred to as a “set frame interval” and a “set frame width,” respectively.

The logic section 22 generates, on the basis of the set frame interval, the set frame width, and event data from the sensor section 21, frame data that is image data in a frame format, to thereby convert the event data to the frame data.

That is, the logic section 22 generates, in each set frame interval, frame data on the basis of event data in the set frame width from the beginning of the set frame interval.

Here, it is assumed that event data includes time point information tᵢ indicating a time point at which an event has occurred (hereinafter also referred to as an “event time point”) and coordinates (x, y) serving as location information regarding (the pixel block 41 including) the pixel 51 in which the event has occurred (hereinafter also referred to as an “event location”).

In FIG. 8, in a three-dimensional space (time and space) with the x axis, the y axis, and the time axis t, points representing event data are plotted on the basis of the event time point t and the event location (coordinates) (x, y) included in the event data.

That is, when a location (x, y, t) on the three-dimensional space indicated by the event time point t and the event location (x, y) included in event data is regarded as the space-time location of an event, in FIG. 8, the points representing the event data are plotted on the space-time locations (x, y, t) of the events.

The logic section 22 starts to generate frame data on the basis of event data by using, as a generation start time point at which frame data generation starts, a predetermined time point, for example, a time point at which frame data generation is externally instructed or a time point at which the sensor device 10 is powered on.

Here, cuboids each having the set frame width in the direction of the time axis t in the set frame intervals, which appear from the generation start time point, are referred to as a “frame volume.” The size of the frame volume in the x-axis direction or the y-axis direction is equal to the number of the pixel blocks 41 or the pixels 51 in the x-axis direction or the y-axis direction, for example.

The logic section 22 generates, in each set frame interval, frame data on a single frame on the basis of event data in the frame volume having the set frame width from the beginning of the set frame interval.

Frame data can be generated by, for example, setting white to a pixel (pixel value) in a frame at the event location (x, y) included in event data and setting a predetermined color such as gray to pixels at other locations in the frame.

Besides, in a case where event data includes the polarity of a change in light amount that is an event, frame data can be generated in consideration of the polarity included in the event data. For example, white can be set to pixels in the case a positive polarity, while black can be set to pixels in the case of a negative polarity. Alternatively, polarity values +1 and −1 may be assigned for each pixel in which an event of the according polarity has been detected and 0 may be assigned to a pixel in which no event was detected.

In addition, in the case where pixel signals of the pixels 51 are also output when event data is output as described with reference to FIG. 3 and FIG. 4, frame data can be generated on the basis of the event data by using the pixel signals of the pixels 51. That is, frame data can be generated by setting, in a frame, a pixel at the event location (x, y) (in a block corresponding to the pixel block 41) included in event data to a pixel signal of the pixel 51 at the location (x, y) and setting a predetermined color such as gray to pixels at other locations.

Note that, in the frame volume, there are a plurality of pieces of event data that are different in the event time point t but the same in the event location (x, y) in some cases. In this case, for example, event data at the latest or oldest event time point t can be prioritized. Further, in the case where event data includes polarities, the polarities of a plurality of pieces of event data that are different in the event time point t but the same in the event location (x, y) can be added together, and a pixel value based on the added value obtained by the addition can be set to a pixel at the event location (x, y).

Here, in a case where the frame width and the frame interval are the same, the frame volumes are adjacent to each other without any gap. Further, in a case where the frame interval is larger than the frame width, the frame volumes are arranged with gaps. In a case where the frame width is larger than the frame interval, the frame volumes are arranged to be partly overlapped with each other. Event time stamp according to the end of the frame width can be set to all values within the event frame.

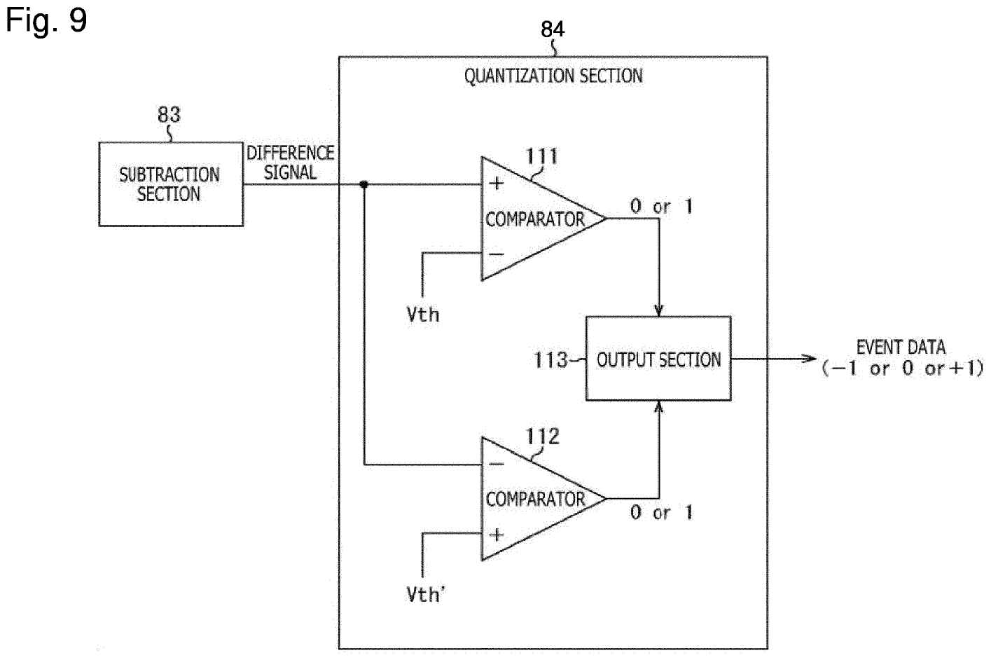

FIG. 9 is a block diagram illustrating another configuration example of the quantization section 84 of FIG. 5.

Note that, in FIG. 9, parts corresponding to those in the case of FIG. 7 are denoted by the same reference signs, and the description thereof is omitted as appropriate below.

In FIG. 9, the quantization section 84 includes comparators 111 and 112 and an output section 113.

Thus, the quantization section 84 of FIG. 9 is similar to the case of FIG. 7 in including the comparator 111. However, the quantization section 84 of FIG. 9 is different from the case of FIG. 7 in newly including the comparator 112 and the output section 113.

The event detecting section 52 (FIG. 5) including the quantization section 84 of FIG. 9 detects, in addition to events, the polarities of changes in light amount that are events.

In the quantization section 84 of FIG. 9, the comparator 111 outputs, in the case where a difference signal is larger than the threshold Vth, the H level indicating 1, as event data indicating the occurrence of an event having the positive polarity. The comparator 111 outputs, in the case where a difference signal is not larger than the threshold Vth, the L level indicating 0, as event data indicating that no event having the positive polarity has occurred.

Further, in the quantization section 84 of FIG. 9, a threshold Vth′ (<Vth) is supplied to the non-inverting input terminal (+) of the comparator 112, and difference signals are supplied to the inverting input terminal (−) of the comparator 112 from the subtraction section 83. Here, for the sake of simple description, it is assumed that the threshold Vth′ is equal to −Vth, for example, which needs however not to be the case.

The comparator 112 compares a difference signal from the subtraction section 83 with the threshold Vth′ applied to the inverting input terminal (−), thereby quantizing the difference signal. The comparator 112 outputs, as event data, the quantized value obtained by the quantization.

For example, in a case where a difference signal is smaller than the threshold Vth′ (the absolute value of the difference signal having a negative value is larger than the threshold Vth), the comparator 112 outputs the H level indicating 1, as event data indicating the occurrence of an event having the negative polarity. Further, in a case where a difference signal is not smaller than the threshold Vth′ (the absolute value of the difference signal having a negative value is not larger than the threshold Vth), the comparator 112 outputs the L level indicating 0, as event data indicating that no event having the negative polarity has occurred.

The output section 113 outputs, on the basis of event data output from the comparators 111 and 112, event data indicating the occurrence of an event having the positive polarity, event data indicating the occurrence of an event having the negative polarity, or event data indicating that no event has occurred to the transfer section 85.

For example, the output section 113 outputs, in a case where event data from the comparator 111 is the H level indicating 1, +V volts indicating +1, as event data indicating the occurrence of an event having the positive polarity, to the transfer section 85. Further, the output section 113 outputs, in a case where event data from the comparator 112 is the H level indicating 1, −V volts indicating −1, as event data indicating the occurrence of an event having the negative polarity, to the transfer section 85. In addition, the output section 113 outputs, in a case where each event data from the comparators 111 and 112 is the L level indicating 0, 0 volts (GND level) indicating 0, as event data indicating that no event has occurred, to the transfer section 85.

The transfer section 85 supplies a request to the arbiter 33 in the case where it is confirmed on the basis of event data from the output section 113 of the quantization section 84 that a change in light amount that is an event having the positive polarity or the negative polarity has occurred. After receiving a response indicating event data output permission, the transfer section 85 outputs event data indicating the occurrence of the event having the positive polarity or the negative polarity (+V volts indicating 1 or −V volts indicating −1) to the output section 35.

Preferably, the quantization section 84 has a configuration as illustrated in FIG. 9.

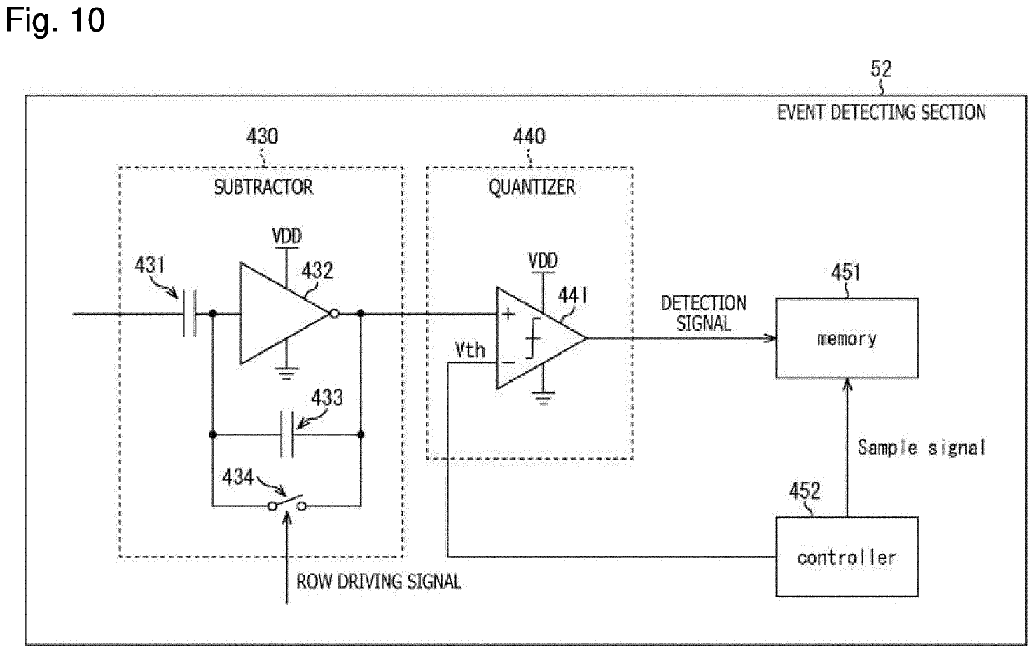

FIG. 10 is a diagram illustrating another configuration example of the event detecting section 52.

In FIG. 10, the event detecting section 52 includes a subtractor 430, a quantizer 440, a memory 451, and a controller 452. The subtractor 430 and the quantizer 440 correspond to the subtraction section 83 and the quantization section 84, respectively.

Note that, in FIG. 10, the event detecting section 52 further includes blocks corresponding to the current-voltage converting section 81 and the buffer 82, but the illustrations of the blocks are omitted in FIG. 10.

The subtractor 430 includes a capacitor 431, an operational amplifier 432, a capacitor 433, and a switch 434. The capacitor 431, the operational amplifier 432, the capacitor 433, and the switch 434 correspond to the capacitor 101, the operational amplifier 102, the capacitor 103, and the switch 104, respectively.

The quantizer 440 includes a comparator 441. The comparator 441 corresponds to the comparator 111.

The comparator 441 compares a voltage signal (difference signal) from the subtractor 430 with the predetermined threshold voltage Vth applied to the inverting input terminal (−). The comparator 441 outputs a signal indicating the comparison result, as a detection signal (quantized value).

The voltage signal from the subtractor 430 may be input to the input terminal (−) of the comparator 441, and the predetermined threshold voltage Vth may be input to the input terminal (+) of the comparator 441.

The controller 452 supplies the predetermined threshold voltage Vth applied to the inverting input terminal (−) of the comparator 441. The threshold voltage Vth which is supplied may be changed in a time-division manner. For example, the controller 452 supplies a threshold voltage Vth1 corresponding to ON events (for example, positive changes in photocurrent) and a threshold voltage Vth2 corresponding to OFF events (for example, negative changes in photocurrent) at different timings to allow the single comparator to detect a plurality of types of address events (events).

The memory 451 accumulates output from the comparator 441 on the basis of Sample signals supplied from the controller 452. The memory 451 may be a sampling circuit, such as a switch, plastic, or capacitor, or a digital memory circuit, such as a latch or flip-flop. For example, the memory 451 may hold, in a period in which the threshold voltage Vth2 corresponding to OFF events is supplied to the inverting input terminal (−) of the comparator 441, the result of comparison by the comparator 441 using the threshold voltage Vth1 corresponding to ON events. Note that, the memory 451 may be omitted, may be provided inside the pixel (pixel block 41), or may be provided outside the pixel.

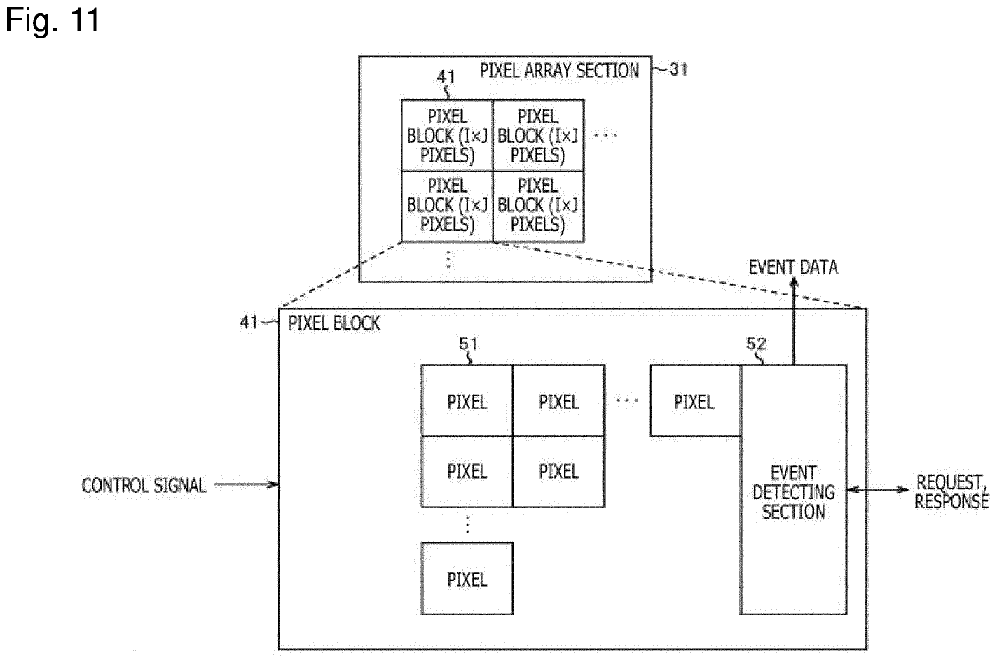

FIG. 11 is a block diagram illustrating another configuration example of the pixel array section 31 of FIG. 2, in which the pixels only serve event detection. Thus, FIG. 11 does not show a hybrid sensor, but an EVS/DVS.

Note that, in FIG. 11, parts corresponding to those in the case of FIG. 3 are denoted by the same reference signs, and the description thereof is omitted as appropriate below.

In FIG. 11, the pixel array section 31 includes the plurality of pixel blocks 41. The pixel block 41 includes the I×J pixels 51 that are one or more pixels and the event detecting section 52.

Thus, the pixel array section 31 of FIG. 11 is similar to the case of FIG. 3 in that the pixel array section 31 includes the plurality of pixel blocks 41 and that the pixel block 41 includes one or more pixels 51 and the event detecting section 52. However, the pixel array section 31 of FIG. 11 is different from the case of FIG. 3 in that the pixel block 41 does not include the pixel signal generating section 53.

As described above, in the pixel array section 31 of FIG. 11, the pixel block 41 does not include the pixel signal generating section 53, so that the sensor section 21 (FIG. 2) can be formed without the AD conversion section 34.

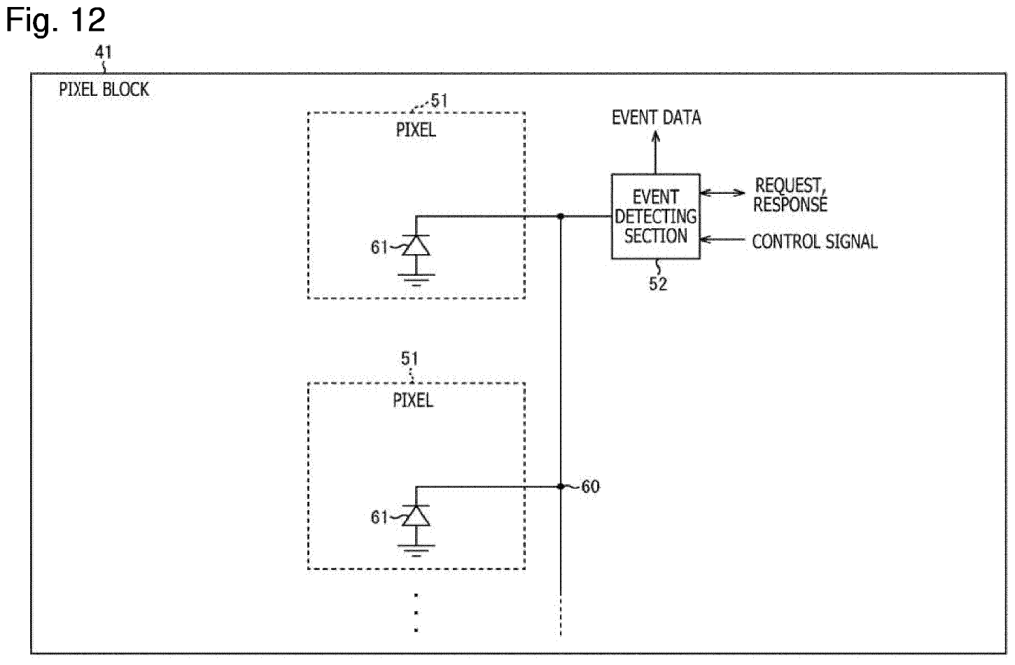

FIG. 12 is a circuit diagram illustrating a configuration example of the pixel block 41 of FIG. 11.

As described with reference to FIG. 11, the pixel block 41 includes the pixels 51 and the event detecting section 52, but does not include the pixel signal generating section 53.

In this case, the pixel 51 can only include the photoelectric conversion element 61 without the transfer transistors 62 and 63.

Note that, in the case where the pixel 51 has the configuration illustrated in FIG. 12, the event detecting section 52 can output a voltage corresponding to a photocurrent from the pixel 51, as a pixel signal.

Above, the sensor device 10 was described to be an asynchronous imaging device configured to read out events by the asynchronous readout system. However, the event readout system is not limited to the asynchronous readout system and may be the synchronous readout system. An imaging device to which the synchronous readout system is applied is a scan type imaging device that is the same as a general imaging device configured to perform imaging at a predetermined frame rate.

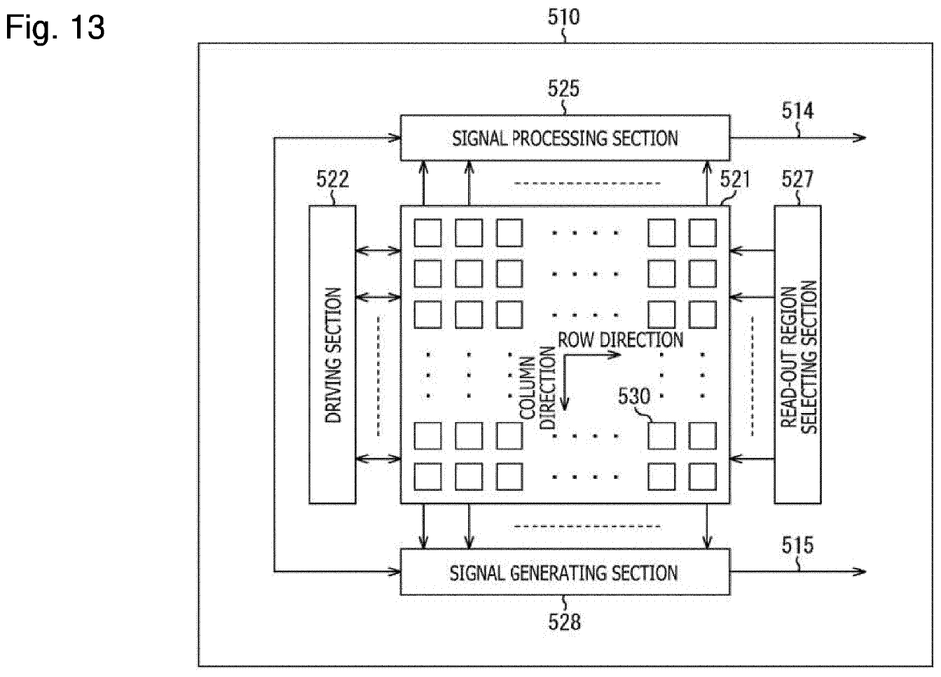

FIG. 13 is a block diagram illustrating a configuration example of a scan type imaging device, i.e. of an active pixel sensor, APS, which may be used in the sensor device 10 together with the EVS illustrated in FIG. 12.

As illustrated in FIG. 13, an imaging device 510 includes a pixel array section 521, a driving section 522, a signal processing section 525, a read-out region selecting section 527, and an optional signal generating section 528.

The pixel array section 521 includes a plurality of pixels 530. The plurality of pixels 530 each output an output signal in response to a selection signal from the read-out region selecting section 527. The plurality of pixels 530 can each include an in-pixel quantizer as illustrated in FIG. 10, for example. The plurality of pixels 530 output output signals corresponding to the amounts of change in light intensity. The plurality of pixels 530 may be two-dimensionally disposed in a matrix as illustrated in FIG. 13.

The driving section 522 drives the plurality of pixels 530, so that the pixels 530 output pixel signals generated in the pixels 530 to the signal processing section 525 through an output line 514. Note that, the driving section 522 and the signal processing section 525 are circuit sections for acquiring grayscale information.

The read-out region selecting section 527 selects some of the plurality of pixels 530 included in the pixel array section 521. For example, the read-out region selecting section 527 selects one or a plurality of rows included in the two-dimensional matrix structure corresponding to the pixel array section 521. The read-out region selecting section 527 sequentially selects one or a plurality of rows on the basis of a cycle set in advance, e.g. based on a rolling shutter. Further, the read-out region selecting section 527 may determine a selection region on the basis of requests from the pixels 530 in the pixel array section 521.

The optional signal generating section 528 may generate, on the basis of output signals of the pixels 530 selected by the read-out region selecting section 527, event signals corresponding to active pixels in which events have been detected of the selected pixels 530. The events mean an event that the intensity of light changes. The active pixels mean the pixel 530 in which the amount of change in light intensity corresponding to an output signal exceeds or falls below a threshold set in advance. For example, the signal generating section 528 compares output signals from the pixels 530 with a reference signal, and detects, as an active pixel, a pixel that outputs an output signal larger or smaller than the reference signal. The signal generating section 528 generates an event signal (event data) corresponding to the active pixel.

The signal generating section 528 can include, for example, a column selecting circuit configured to arbitrate signals input to the signal generating section 528. Further, the signal generating section 528 can output not only information regarding active pixels in which events have been detected, but also information regarding non-active pixels in which no event has been detected.

The signal generating section 528 outputs, through an output line 515, address information and timestamp information (for example, (X, Y, T)) regarding the active pixels in which the events have been detected. However, the data that is output from the signal generating section 528 may not only be the address information and the timestamp information, but also information in a frame format (for example, (0, 0, 1, 0, . . . )).

Above, different sensor designs have been discussed which combine the capability to generate event data and full intensity pixel signals e.g. by sharing pixel signals between different circuitries, by dividing a pixel to have both functionalities or by combining event data and pixel signals of different sensor chips or sensors. It is understood that the above is merely exemplary and that any other implementation may be chosen that allows a concurrent generation of event data and intensity signals.

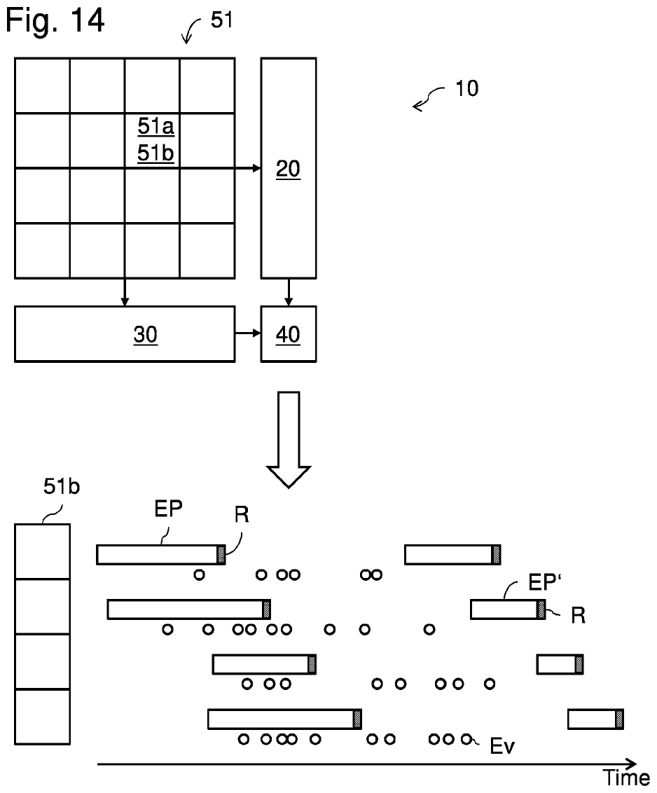

In all these examples a sensor device 10 as shown in FIG. 14 is provided that comprises a plurality of pixels 51 that are each configured to receive light and perform photoelectric conversion to generate an electrical signal. The sensor device 10 may be any kind of camera. For example, the sensor device 10 may be used in a smartphone or the like.

The sensor device 10 further comprises event detection circuitry 20 that is configured to generate event data by detecting as events intensity changes above a predetermined threshold of the light received by each of event detecting pixels 51a that form a first subset of the pixels 51, and pixel signal generating circuitry 30 that is configured to generate pixel signals indicating intensity values of the light received by each of intensity detecting pixels 51b that form a second subset of the pixels 51.

Here, the pixel signals generated during each of a series of frame periods constitute frame images that indicate intensity values of the light received by each of the intensity detecting pixels during respective exposure periods. Differently stated, each intensity detecting pixel 51b gathers light during an exposure period. The time necessary to receive the light, to convert the gathered light to an electrical signal, and to read out the electrical signal for all intensity detecting pixels 51b defines the frame period, i.e. the time necessary to generate one frame of full intensity values.

As illustrated in FIG. 14, each of the pixels 51 may function as event detection pixel 51a and as intensity detecting pixel 51b. The pixels 51 may have both functionalities at the same time by distributing the electrical signal generated by photoelectric conversion at the same time to the event detection circuitry 20 and the pixel signal generating circuitry 30.

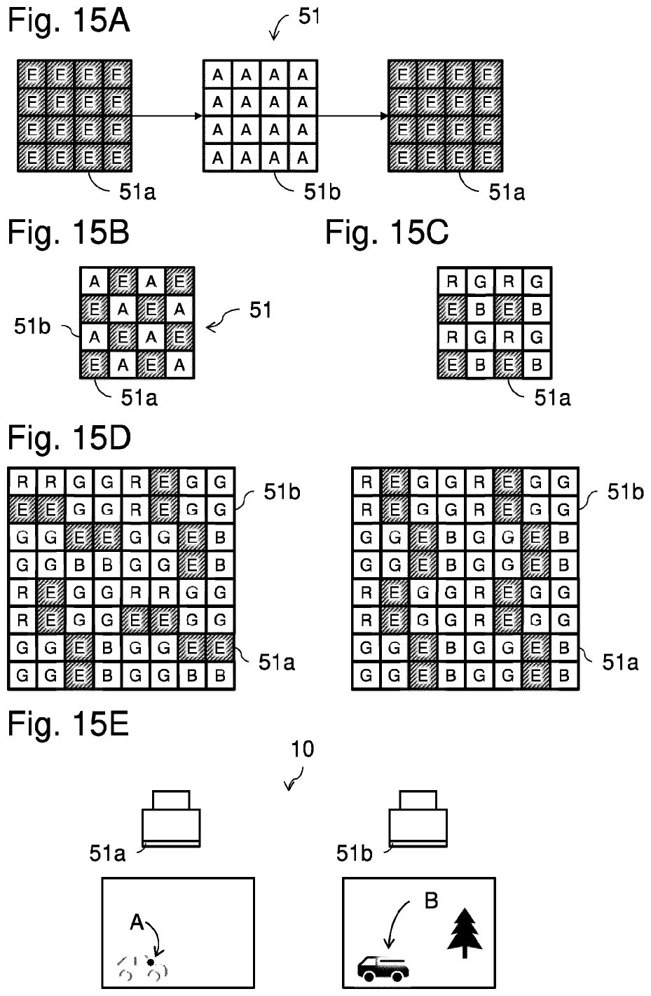

Alternatively, the pixels 51 may be switched between event detection and pixel signal generation as e.g. described above with respect to FIG. 4 and schematically illustrated in FIG. 15A. Here, it is assumed that all pixels 51 operate first as event detecting pixels 51a and switch then to an operation as intensity detecting or APS pixels 51b. Afterwards, the cycle starts again with event detection functionality.

Thus, the first subset of pixels 51 may be equal to the second subset of pixels 51. Alternatively, the first and second subsets of pixels 51 may at least in parts be different. This is exemplarily illustrated in FIGS. 15B to 15E.

Here, FIG. 15B shows a situation in which event detecting pixels 51a are arranged in an alternating manner with intensity detecting pixels 51b. Thus, it is possible to capture event and intensity information simultaneously by using different sets of EVS and APS pixels.

FIGS. 15C and 15D show examples of RGB-Event hybrid sensors in which color filters are provided on each of the intensity detecting pixels. This allows capturing both, color image frames and events. Here, different exposure times may be used for pixel signal and event data readout, e.g. a fixed frame rate can be set for readout of RGB frames, while events are readout asynchronously at the same time. As schematically indicated in FIG. 15D pixels having the same color filter or the same functionality can be read out together as single pixels.

Of course, it is to be understood that the arrangement of color filters and event detecting pixels 51a within the pixel array may be different than shown in FIGS. 15B to 15D. Moreover, the sensor device 10 may include further event detecting pixels 51a and/or intensity detecting pixels 51b that have both functionalities and/or are not part of the pixel array.

The above examples relate to pixels 51 belonging to different pixel subsets, but being part of a single sensor chip. However, the event detecting pixels 51a and the intensity detecting pixels 51b may also be part of different sensor chips or even different cameras of the sensor device 10.

For example, FIG. 15E shows a stereo camera constituting the sensor device 10 in which one camera uses event detecting pixels 51a, i.e. is an EVS, while the other camera uses intensity detecting pixels 51b, i.e. is an APS. Here the EVS captures moving objects (like the car in the example of FIG. 15E) with a high time resolution and low latency, while the APS captures all objects on the scene (car and tree) with a smaller temporal resolution.

In all of the above examples the generation of event data and the generation of pixel signals are synchronized such as to allow an assignment of time according to the same time coordinate to event data generation and pixel signal generation. Differently stated, both the event detection circuitry 20 and the pixel signal generation circuitry 30 operate based on the same clock cycle, not only in the case of a shared pixel array, but also for a system of geometrically separated pixel arrays as the one of FIG. 15D.

As illustrated in FIG. 14 a control unit 40 is part of the sensor device 10. The control unit 40 may be constituted by any circuitry, processor or the like that is capable to carry out the functions described below. The control unit 40 may be implemented as hardware, as software or as a mixture of both. It may be part of the sensor chip or may be located externally, e.g. on its own chip.

The control unit 40 is configured to associate with each other event detecting pixels 51a and intensity detecting pixels 51b that have a corresponding field of view. Differently stated, the control unit 40 is able to establish a mapping of event data to intensity values captured by the intensity detecting pixels 51b. In this manner the data obtained by the intensity detecting pixels 51b can be supplemented pixel-wise with event data, like e.g. the number of events or the like, obtained from the event detecting pixels. The association between the pixels 51 may be done in any suitable manner.

For example, pixel row numbers (and column numbers) can be assigned to events based on pixels 51 that function as both, event detecting pixels 51a and intensity detecting pixels 51b. In particular, if all pixels 51 have both functionalities as shown in FIG. 14 or 15A, the position of a pixel 51 in the pixel array automatically assigns a row and column number. Based on this information pixel row numbers can be extrapolated to event detecting pixels 51a that do not have pixel signal generating functionalities, but are part of the pixel array.

Further, for cases as shown in FIGS. 15B to 15D where functionalities are separated between the pixels 51 of the different subsets, it is possible to assign row and column numbers to the event detecting pixels 51b by knowing the “holes” in the APS pixel array into which the event detecting pixels 51b are filled. In particular, address spaces for the EVS pixels can be set up such that row and column numbers are not counted for adjacent event detecting pixels 51a, but according to the overall pixel array.

In principle, the control unit may also assign pixel row numbers to the events based on an analysis of the information captured by the event detecting pixels 51a and the intensity detecting pixels 51b. Since both pixel subsets capture the same scene, it is possible to determine the pixel row and column numbers of the event detecting pixels 51a (and of the respective detected events) by spatially registering both images of the scene and by using the pixel grid defined by the intensity detecting pixels 51b also for the image generated from the event detecting pixels 51a.

In this manner it is also possible to spatially register events of an EVS camera to pixel rows of a separate APS camera as illustrated in FIG. 15E. Here, it is first necessary to spatially register the outputs of both cameras as is known for conventional stereo camera, i.e. by using intrinsic and extrinsic parameters. In this process, it will only be possible to register each event with an epipolar line in the APS image due to the in principle unknown scene depth.

As indicated by arrows A and B in FIG. 15E a single point in the EVS image (A) can only be mapped to an epipolar line in the APS (B). However, if the exposures of the APS pixels are controlled in large block units or entire sensor area, there is no need to take a precise pixel-by-pixel correspondence between APS and EVS pixels, and the ambiguity of epipolar line in the APS (B) does not matter. Alternatively, if both cameras are placed horizontally, which is the usual setup, the epipolar lines in the APS image will be parallel to the pixel rows. In this manner it is possible to assign pixel row numbers to the events by identifying the corresponding epipolar lines. For the cameras whose APS pixels are controlled row-wise, the matching between APS-row and EVS-row is enough, because all APS pixels in the same row are controlled by the same parameter. For cameras that are arranged with parallel pixel rows this allows the control unit 40 to correlate time stamps of the pixel signals with event time stamps by using epipolar lines on the camera having the intensity detecting pixels 51b. Alternatively, it is also possible to register pixel-by-pixel correspondence between APS pixels and EVS pixels. the shape of accumulating events for a certain period of time and the edge of the APS image have a similar structure. Therefore, it is possible to make a correspondence between the EVS image and APS image by finding a part similar to the structure of the event around point A from the edge of the APS image on the epipolar line B. By repeating this calculation around the parts of all events, the correspondence between A and B can be established.

The control unit 40 is therefore configured to assign event data and pixel signals with each other. This allows an improvement of the frame image encoded in the pixel signals by using supplementing information encoded in the event data. In particular, the control unit 40 is configured to dynamically change the exposure periods of the intensity detecting pixels 51b based on the events detected by the associated event detecting pixels 51a.

This is schematically illustrated in the lower part of FIG. 14. Here, four intensity detecting pixels 51b are shown as representation of the plurality of intensity detecting pixels 51b. Each intensity detecting pixel 51b gathers light during an exposure period EP after which the pixel signal corresponding to that pixel is readout in a readout process R. As shown in FIG. 14 each intensity detecting pixel 51b may have an exposure period EP of a different length. Here, it should be noted that the arrangement of intensity detecting pixels 51b in a column is exemplary and that also intensity detecting pixels 51b in the same row may have their own exposure periods EP that may differ from each other. However, as exemplarily assumed for the sake of simplicity in the larger part of the following description, exposure periods EP may also be the same for some pixel groups, like e.g. for all intensity detecting pixels 51b in the same row.

Also schematically illustrated in the lower part of FIG. 14 are event data Ev. Here, the occurrence of an event at a certain point in time is indicated by a point. Moreover, event data Ev are grouped according to the assignment between the event detection pixel 51a that has detected the event and the corresponding intensity detecting pixel 51b. Thus, to each intensity detecting pixel 51b a series of events can be attributed. Differently stated, for each part of a frame image of an observed scene it is possible to identify the events caused within the part of the frame image and their temporal distribution.

These event data Ev provide additional information beyond the intensity information captured by the event detecting pixels 51b. In particular, during the exposure periods EP the event detecting pixels 51b are “blind” in the sense that information captured by them is only output in the following readout process R. Thus, extracting information from the captured frame images is only possible after the readout process R, i.e. with a high latency. In contrast, event data is continuously produced with a latency that is much smaller than the latency of frame image production. The time constant of event detection may for example be a factor 1,000 smaller than the time constant of frame image generation. Thus, information about intensity changes can be provided almost real-time as event data during the exposure periods EP, which allows a fast adaption of the imaging parameters.

Further, extracting particular information from a frame image, such as e.g. an amount of motion, a brightness level, presence of a specific feature in a scene or the like, is comparatively complex, since the pixel signal of each pixel in the frame image needs to be accessed, even if it does not contribute to the information of interest. In contrast, processing event data is less complex, since the data amount thereof is reduced by omitting all “redundant” pixels, i.e. all pixels that do not show a change in intensity. Moreover, events represent automatically filtered information due to their change-based detection, and are thus suited e.g. for motion detection, brightness estimation or feature detection of moving features.

Thus, in addition to be faster at hand than the full intensity frame images processing event data is also computationally less complex, which additionally reduces the latency of event data processing/evaluation.

Based on this low latency information, i.e. based on the event data, the control unit 40 adjusts the exposure periods EP of the intensity detecting pixels 51b. This means that based on the event data Ev it can be decided whether the respective intensity detecting pixels 51b capture the scene only for a short time period or whether the received light is integrated in the intensity detecting pixels 51b for a longer time. If the scene is captured only for a short time, overexposure is avoided, however, for the risk of underexposure. At the same time, the occurrence of motion blur is reduced, however, for the cost of a reduced signal to noise ratio. For long exposure the opposite applies. Thus, the pixel signal of each intensity detecting pixel 51b can be improved by choosing an appropriate exposure period EP, which can be set dynamically for each frame period based on the concurrently detected events.

As illustrated in the lower part of FIG. 14, the exposure periods EP of all intensity detecting pixels 51b can be set to adjusted exposure periods EP′ that may in principle differ from each other. However, the adjusted exposure periods EP′ may also be the same for all intensity detecting pixels 51b or for groups of intensity detecting pixels 51b such as pixel rows or specific areas in a pixel area/a frame image.

The control unit 40 may in particular be configured to deduce an amount of motion and/or a brightness level from the events detected by the event detecting pixels 51a. This may e.g. be achieved by counting the events detected during a given time period, such as the frame period, a previous exposure period or a freely settable time period, in a given area of a frame image, like e.g. for a single pixel or within a group of pixels. The number of changes of intensity above the event detection threshold is a direct measure for the overall change of intensity at the corresponding intensity detecting pixel 51b. This change might e.g. caused by the appearance (and/or disappearance) of an object, i.e. by motion, or by a change of brightness, e.g. due to a change of the observed scene or the illumination conditions within the scene. Thus, counting the events detected for each intensity detecting pixel position or each row of intensity detecting pixels 51b is a simple, but effective means to deduce an amount of motion and/or a brightness level.

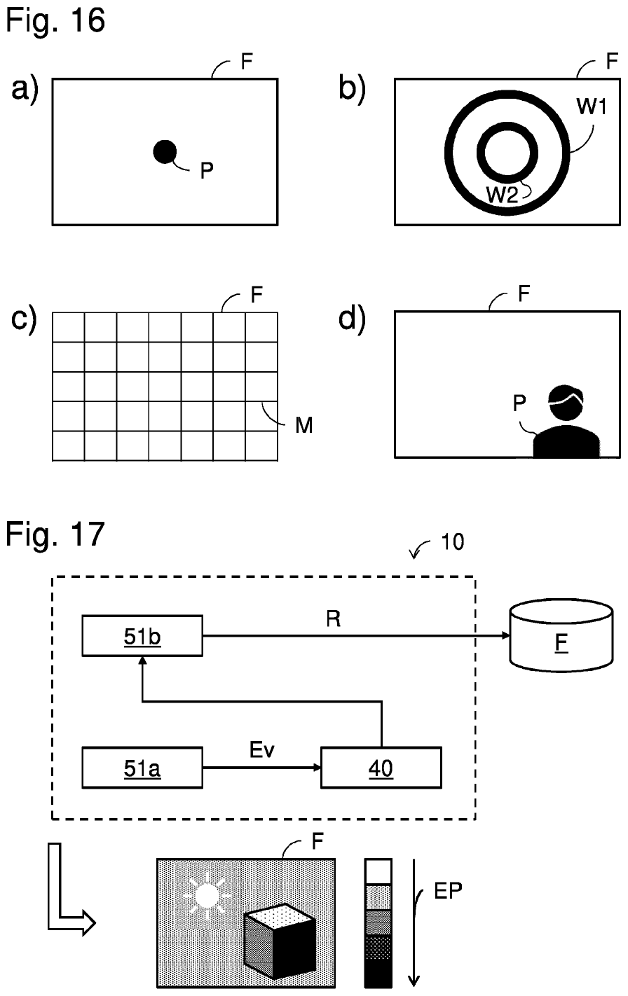

This might be supplemented by additional, more sophisticated methods. As illustrated in FIG. 16 a), spot metering, i.e. detecting the number of events around a predetermined range point P within a frame image F, like e.g. the center point, can be used to deduce motion and/or brightness. Just the same, as shown in FIG. 16 b) the number of events might be weighted depending on the distance from a range point such as the center point. This is schematically indicated in FIG. 16 b) by circles at which weights W1 and W2 are applied, respectively.

An alternative to this approach is schematically shown in FIG. 16 c) where not the events at or centered around a specific point are taken into account, but the events across the entire screen, e.g. at lines M of a line matrix, which might be equivalent to the pixel resolution of the frame image F, or by calculating an area density of event across the frame image F.

Further alternatively as shown in FIG. 16 d), an object, like a person P, might be identified in a frame image F, and the number of events is counted in the area occupied by the object.

Of course, the above event evaluation methods might be combined with each other or with a pixel-wise/row-wise/column-wise number counting, if necessary.

The control unit 40 is then configured to adjust the exposure periods EP such that a larger amount of motion and/or a larger brightness level leads to a shorter exposure period, while a smaller amount of motion and/or a smaller brightness level leads to a longer exposure period. Accordingly, for fast motions and/or for brightly illuminated scenes (or scene parts) the exposure period is made short, e.g. in the range of 1.0 ms, for example 0.5 ms or 2 ms. Thus, motion blur can be reduced and overexposure avoided. On the other hand, if there is no or only little motion or if illumination is low/the scene is dark, the exposure period can be chosen to be long, e.g. in the range of 33 ms, for example 20 ms or 50 ms. This ensures a high signal to noise ratio at times/scene parts where no motion blur will occur. Further, underexposure is avoided.

In this manner the event data Ev can be used to significantly improve the resulting frame images F by reducing motion blur, wherever necessary, keeping the signal to noise ratio high, where possible, and by avoiding overexposure as well as underexposure.

As already mentioned above, the control unit 40 is configured to adjust the exposure period of each of the intensity detecting pixels 51b separately. This is exemplary illustrated in the functional bock diagram at the top of FIG. 17. Each event detecting pixel 51a generates event data Ev corresponding in position to the part of the scene observed by the associated intensity detecting pixel 51b. The control unit 40 gathers the event data Ev and controls the exposure period EP used by the associated intensity detecting pixel 51b (or the pixel signal generating circuitry 30). The pixel signal produced during this adjusted exposure period EP is output in readout process R to form frame image F.

The manner of adjustment is exemplarily shown in the lower part of FIG. 17. Here a frame image F is illustrated that shows next to the sun a cube illuminated by the sun. While the sun is very bright, faces of the cube have different brightness levels due to shading. The control unit 40 is capable to recognize these brightness levels based on the detected events and adjust the exposure period EP as indicated by the right hand scale, i.e. the shortest exposure periods for the brightest parts and the longest exposure periods for the darkest parts and an in between lying range of exposure periods for the in between lying brightness levels. In this manner, brightness differences in the scene can be levelled and a high dynamic range frame image can be produced.

Again, it should be noted here that exposure period adjustment could in principle also be achieved by evaluating the previous frame image(s). However, this would suffer from a high latency since generation of one (or even several) frame image(s) has to be awaited. The process discussed herein is much faster, since generation of event data is much faster than reconstruction of a frame image.

The above description applies in particular to the case where each pixel 51 captures pixel signals by using a single exposure period EP. This is in principle unproblematic, when the exposure periods EP of all intensity detecting pixels 51b are adjusted separately. However, if pixel groups, like e.g. entire rows or columns of a pixel array, or pixels 51 forming a subframe of frame image F use the same exposure period EP, which differs however from the exposure periods EP used in neighboring intensity detecting pixels 51b, image artifacts may be generated. For example, if exposure periods EP are adjusted row-wise, horizontal boundaries might be visible in the frame image F. On the other hand, a grouped exposure time setting may be advantageous due to the reduced complexity of circuitry and control signaling.

To mitigate this specific problem, the pixel signal generating circuitry 30 may generate during each frame period at least two sets of pixel signals with at least two differing exposure periods EP1, EP2, and the control unit 40 may be configured to adjust the shorter exposure period EP2, while the longer exposure period EP1 is fixed. The frame image F is then generated from the two sets of pixel signals, as it is in principle known for the generation of high dynamic range images from a plurality of frames captured consecutively with different exposure periods.

In this manner the advantages of conventional HDR image generation can be combined with the advantages of exposure period adjustment discussed above. In fact, using two (or more) sets of pixel signals (or intermediate frame images) that were captured with different exposure times provides already an improvement of the dynamic range. Moreover, the pixel signal set captured with the smaller exposure period will itself contain less motion blur than its long exposure period counterpart, while the long exposure period pixel signal set can be used to mitigate problems with low signal to noise ratios of the short exposure period pixel signal set.

Providing then in addition the possibility to adjust the shorter exposure period(s) EP2 as discussed above helps to fine-tune the resulting frame image F to its optimum regarding dynamic range, underexposure and/or overexposure. On the other hand, by keeping the longer (or the longest) exposure period EP1 constant over all pixels 51 and over all frame periods helps to avoid image artifacts since all parts of each frame image have a common reference in the long exposure period pixel signal set. It has to be noted that although a fixed longer exposure period EP1 is preferable, also the longer exposure period EP1 might be adjustable.

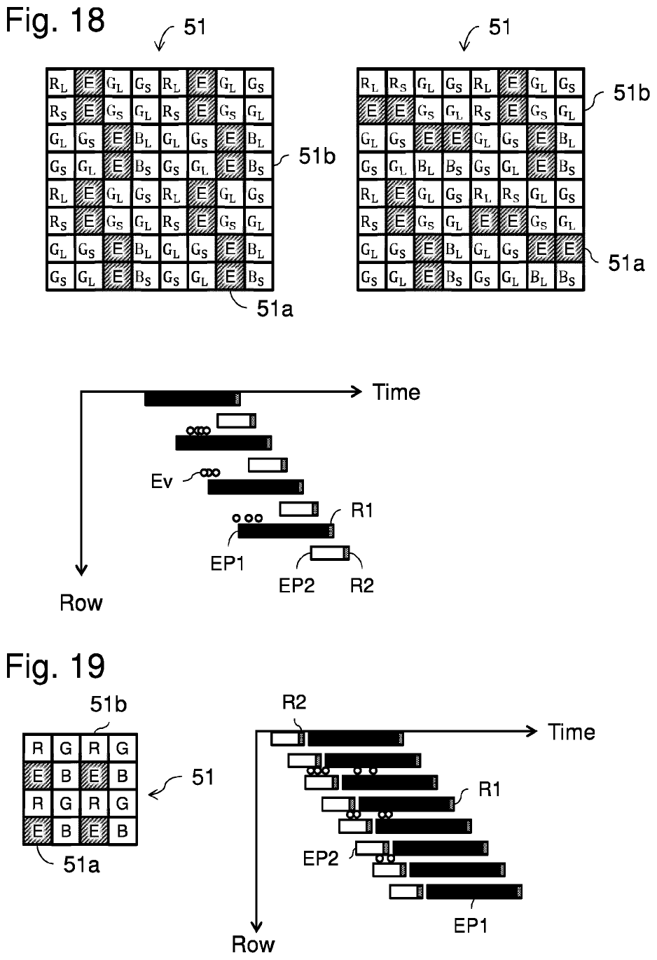

Examples for generating the (at least) two sets of pixel signals are illustrated in FIGS. 18 and 19. In both cases the intensity detecting pixels 51b are arranged in a two dimensional array comprising a plurality of rows.

According to a first alternative exemplarily illustrated in FIG. 18 the control unit 40 is configured to read out pixel signals of the intensity detecting pixels 51b in a row based manner such that for each row pixel signals of different exposure periods are generated simultaneously.

This can be achieved e.g. by providing intensity detecting pixels 51b having different exposure periods EP1, EP2 as shown at the top of FIG. 18. The two pixel arrays shown there are variants of the pixel arrays illustrated in FIG. 15D, where intensity detecting pixels 51b of the same RGB color block are divided into long exposure (X_{L}) and short exposure (X_{S}) pixels. Thus, in each row there are pixels having long exposure periods EP1 and short exposure periods EP2. When applying e.g. a rolling shutter approach, as schematically illustrated in the lower part of FIG. 18, exposure of the short exposure period pixels X_{S} can be started while exposure of the long exposure period pixels X_{L} of the same row is still continued. The starting time for exposure may here be dictated by the need to temporally arrange readout processes R1, R2 in an equidistant manner. As usual for a rolling shutter readout, exposure of the next row starts already during exposure of the previous row. Here, since the exposure period EP1 of the long exposure pixels X_{L} is longer than the exposure period EP2 of the short exposure pixels X_{S}, exposure of long exposure pixels X_{L} of the next row(s) will typically start before exposure of short exposure pixels X_{S} of the current row.

In this manner, it is possible to generate the two sets of pixel signals with different exposure periods EP1, EP2 with only a small extension of the frame period, if compared to the single exposure period case.

An alternative to the above method is schematically illustrated in FIG. 19. Here, the control unit 40 is configured to read out pixel signals of the intensity detecting pixels 51b in a row based manner such that for each row pixel signals of different exposure periods EP1, EP2 are read out consecutively. Such a time-multiplexed readout scheme can be carried out with basically any pixel arrangement. Exemplarily, the arrangement of FIG. 15C is shown.

As indicated on the right hand side of FIG. 19, each row is first read out after each pixel has been exposed with the shorter exposure period EP2 and is then read out again after exposure with the longer exposure period EP1. Also in this time-multiplexed manner two sets of pixel signals can be generated while the overall frame period is only little prolonged if compared to conventional APSs with only a single exposure period.

It has to be understood that in the above the order of the long and short exposure periods is arbitrary, just as the number of exposure periods. In particular, it will be possible to use also more than two exposure periods. Here, exposure and readout may either be fully parallel according to the example of FIG. 18 or fully consecutively according to the example of FIG. 19, but may also be mixed, e.g. by providing one set of intensity detecting pixels 51 for the longest exposure period and one set of intensity detecting pixels 51 for time multiplexed operation with two or more shorter and adjustable exposure periods.

In principle, the more different exposure periods EP, the higher the dynamic range will be. Here, the number of different exposure periods might only be limited by the constraints that during each exposure sufficient signal must be gathered to reach a sufficiently high signal to noise ratio. Further constraints may be the limited chip size (for the parallel readout case) or the need to keep the frame rate, i.e. the inverse frame period, sufficiently high for a video.

As already discussed in detail above between the pixel array formed by the intensity detecting pixels 51b the event detecting pixels 51a may be arranged. All the pixels 51 may also operate as event detecting pixels 51a in a time multiplexed manner, e.g. during interruptive intervals, such as to provide event data during intensity detecting pixel exposure. In both manners, it is possible to provide a stream of event data in parallel to intensity detecting pixel exposure, which can be assigned to the respective pixels (or pixel rows in the discussed example), as indicated by the points in FIGS. 18 and 19. This stream of event data Ev serves as basis for exposure period variations as discussed below.

Further, the control unit 40 may not only be configured to adjust the (shorter) exposure periods, but may also be configured to set different frame periods for each set of pixel signal and to adjust the frame periods concurrently with the exposure periods. In fact, as is apparent from FIG. 18, if long exposure pixels X_{L} and short exposure pixels X_{S} are operated in parallel the short exposure pixels X_{S} will be idle for considerable amounts of time. This leads to an unnecessary loss of information that can be avoided by not only changing the shorter exposure period EP2, but also the frame rate of the according readout cycle.

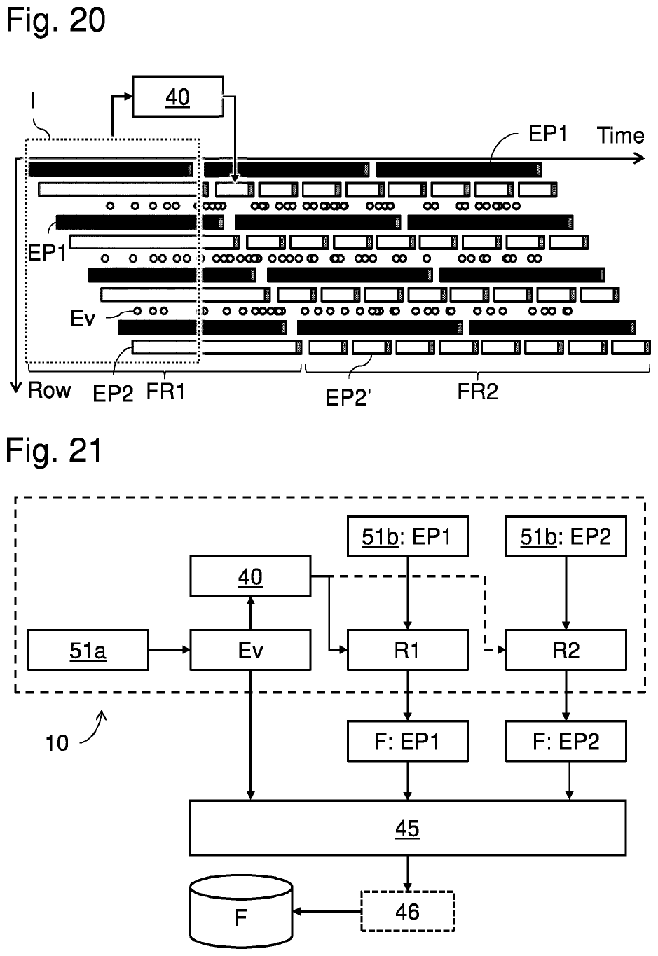

This is exemplarily illustrated in FIG. 20. FIG. 20 shows a first time period in which long exposure pixels X_{L} as well as short exposure pixels X_{S} are exposed with exposure periods EP1, EP2 that are the same. Both readout cycles operate with the same, first frame rate FR1.

During operation events detected at the same time by the event detecting pixels 51a are monitored. For example, all events occurring in a spatiotemporal input window I are counted by the control unit 40. Based on the observed events the control unit 40 decides to shorten the exposure period EP2 of the short exposure pixels X_{S} to an adjusted short exposure period EP2′.

At the same time the control unit 40 increases the frame rate FR1 for the readout of the short exposure pixels X_{S} to an adjusted frame rate FR2 that allows a continuous readout of these pixels despite the reduced exposure period EP2′. The increase of the framerate FR2 or the decrease of the frame period of the readout cycle for the short exposure pixels X_{S} follows the decrease of the shorter exposure period EP2′, e.g. proportionally.

In this manner it is ensured that none of the intensity detecting pixels 51b is idle. Accordingly, a plurality of sets of pixel signals or intermediate frame images captured with short exposure period EP2 are produced while one set of pixel signals or intermediate frame images with long exposure period EP1 is captured. This allows further improving the quality of the resulting frame image F, since the plurality of pixel signals with reduced motion blur can be used to increase the low signal to noise ratio in each pixel signal set, i.e. in each intermediate frame image, according to in principle well known techniques.

The control unit 40 may also be configured to execute a neural network 45 that receives for each frame period all sets of pixel signals and the event data Ev generated during the frame period and that outputs the frame image F. This is schematically illustrated in the functional block diagram of FIG. 21.

FIG. 21 shows the sensor device 10 containing the event detecting pixels 51a and the at least two sets of intensity detecting pixels 51b operated with different exposure period EP1, EP2. The event detecting pixels 51a generate event data Ev that are monitored by the control unit 40 to adjust the exposure periods EP1, EP2, e.g. by determining when to start readout processes R1, R2. This will produce a long exposure intermediate frame image F:EP1 and a short exposure intermediate frame image F:EP2. The pixel signals leading to these intermediate frame images are input together with the event data Ev into the neural network 45 that is trained to fuse all available data to generate the final frame image F (optionally with an intermediate post processing step 46).

Training of the neural network might be performed by simulating the sensor device's 10 outputs based on known images such that the difference between the result generated by the neural network 45 and the known image becomes minimal. Since the neural network 45 operates based on at least three data sets, i.e. the event data Ev and the at least to sets of pixel signals, the quality of the resulting frame images F can be enhanced.

In an alternative manner a rule based algorithm is used to generate the final frame image F. Here, the event data Ev may be used to estimate the blur present in both the short and the long exposure intermediate frame images, i.e. to estimate the respective point spread function. Here, due to the local nature of the event data also the estimation of the point spread function may be carried out locally or area-wise. This estimate for the point spread function may then be used to extract a blur-less image from all available sets of pixel signals. Fusion of these (in principle) blur-less images will then produce a sharp final frame image F with high signal to noise ratio. Of course, any other algorithm known to a skilled person may be used to generate the final frame image F from the event data Ev and the at least two sets of pixel signals captured with different exposure periods EP1, EP2.

As discussed above exposure periods EP may in principle be set pixel-wise. However, also groups of intensity detecting pixels 51b might be formed that share the same exposure period.

For example, the control unit 40 may be configured to set with a single command the same exposure period EP1, EP2 for all intensity detecting pixels 51b. Alternatively, the control unit 40 may be configured to set different exposure periods EP2 in different parts of a frame image F.

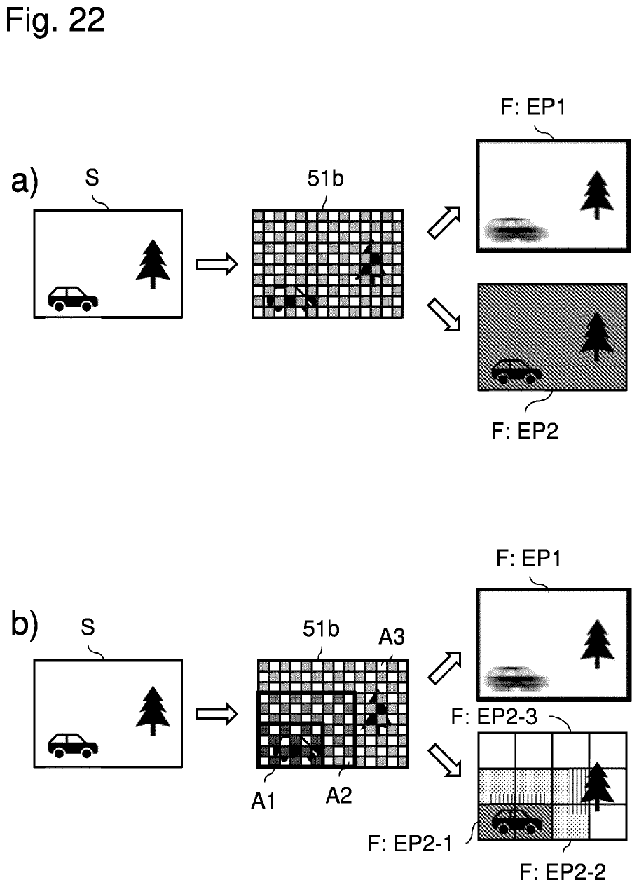

These two examples are schematically illustrated in FIG. 22. FIG. 22 a) shows a scene S including a moving object (a car) and a still standing object (a tree). The frame image F is captured by intensity detecting pixels 51b having a single long exposure period EP1 and a single short exposure period EP2. This leads to an intermediate frame image F:EP1 of long exposure that has a good signal to noise ratio, but contains motion blur in the region of the moving car, and to an intermediate frame image F:EP2 with reduced motion blur, but also reduced signal to noise ratio. These intermediate frame images are then fused as described above to produce the final frame image F.

FIG. 22 b) shows the same scene S. However, in this example different exposure periods EP2-1, EP2-2, EP2-3 are set to different groups of intensity detecting pixels 51b according to the area A1, A2, A3 observed by each group. While the area A1 containing the car is captured with the shortest exposure period EP2-1 the area A3 containing the tree is captured with the longest exposure period EP2-3. An in between area A2 is captured with exposure period EP2-2. In addition, the entire scene is captured with the fixed long exposure period EP1. Of course, the number of three exposure periods used here is merely an example and any other number of exposure periods/areas could be used. In addition, areas do not necessarily have to be arranged block-wise. Every row or groups of several rows may have different exposure periods. Then, blocks are row-shaped. Just the same, every pixel 51 could have a different exposure period, i.e. blocks and pixels 51 can be the same.

This produces an intermediate frame image F:EP1 with high signal to noise ratio, but with motion blur in the area of the car. Further, an intermediate frame image is produced consisting of a first region F:EP2-1 in which motion blur is strongly reduced due to the applied short exposure period EP2-1, but where the signal to noise ratio is low, a second region F:EP2-2 with intermediate motion blur and signal to noise ratio and a third region F:EP2-3 with exposure period EP2-3, motion blur and signal to noise ratio similar to the long exposure intermediate frame image F:EP1. Thus, in this example the control unit 40 is configured to set different short exposure periods EP2-1, EP2-2, EP2-3 in a tailor made manner such as to optimize the signal to noise ratio wherever this is allowed by the (non-) occurrence of motion. As described above, motion detection or estimation is done via the event data observed by the event detecting pixels 51a.

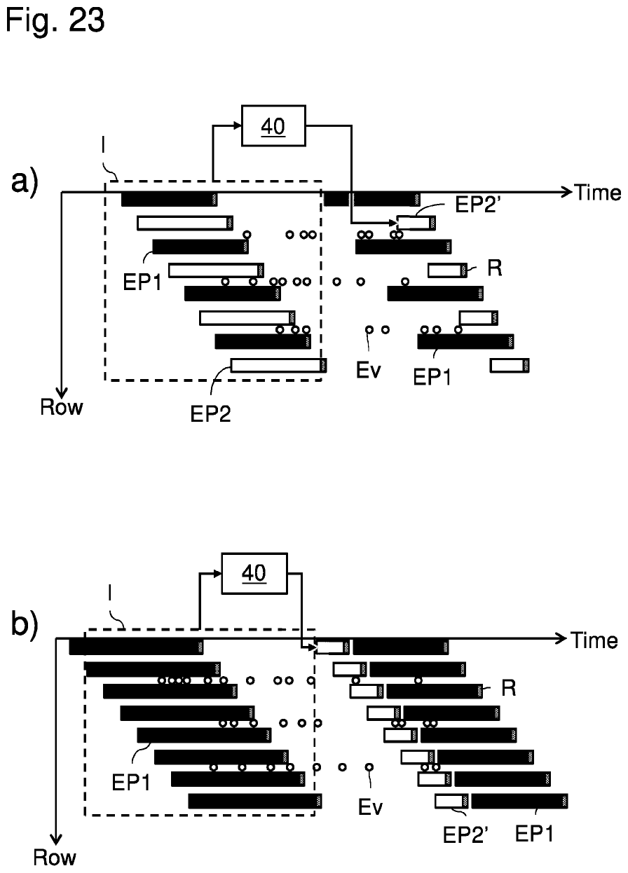

Next, examples will be given regarding the switching between different exposure periods EP2. According to a first example the control unit 40 is configured to evaluate the events detected during a current frame period and to adjust the exposure periods EP2 within the next frame period based on the result of the evaluation. Examples of this process according to the two types of pixel layout discussed above with respect to FIGS. 18 and 19 will be given in FIGS. 23 a) and b).

Here, FIG. 23 a) refers to the case in which exposure of long exposure pixels X_{L} and short exposure pixels X_{S} is carried out in parallel. The control unit 40 monitors event detection during spatiotemporal input window I that comprises all pixel rows and continues until the end of the frame period, i.e. until the last readout process R has been started. Based on the event data generated during this input window I the short exposure period EP2 is set to an adjusted exposure period EP2′, e.g. since the counted number of events was higher than a threshold.

Just the same, in the case shown in FIG. 23 b) in which long exposure pixels X_{L} and short exposure pixels X_{S} are exposed and read out consecutively, an input window I is used that covers an entire frame period and the entire pixel array. Again, the control unit 40 monitors the events detected in this input window I and adjusts the short exposure period EP2. For example, as shown in FIG. 23 b) the sensor device 10 is switched from a case in which no second exposure period is used to a case where the adjusted second exposure period EP2′ is non-zero.

For the sake of simplicity the above examples referred to the case, where a single control signal is used to set the exposure periods EP2′ of all intensity detecting pixels 51b at the beginning of each frame period. It is understood that different input windows I may be used for different pixels, rows, columns or freely adjustable pixel groups, which count events detected by the respective event detecting pixels 51a. In this manner the above described area-wise adjustment of the second exposure period EP2 can be achieved in a frame to frame manner.

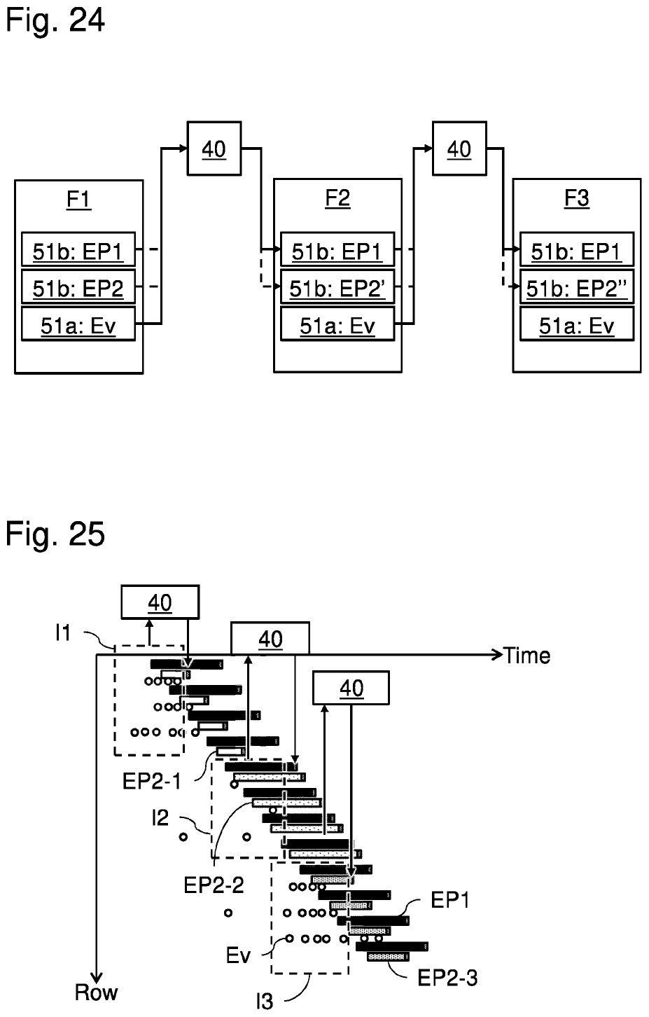

This is summarized in the functional block diagram of FIG. 24. Here, exemplarily three frames image F1, F2, F3 are shown. During capturing of each frame image the pixel signals obtained with different exposure periods EP1, EP2 at the respective intensity detecting pixels 51b:EP1 and 51b:EP2 are provided to the control unit 40. Just the same, the event data Ev are provided from the respective event detecting pixels 51a:Ev to the control unit 40. The control unit 40 evaluates the event data Ev, e.g. by counting events in one or more spatiotemporal input windows, and provides control signals for adjusting the exposure periods EP1, EP2. As indicated in FIG. 24 preferably the longer exposure period EP1 remains fixed, while the shorter exposure period(s) EP2 is adjusted to a new value EP2′. Then frame image F2 is captured with the new parameters and the process is reiterated to obtain the exposure period EP2″ for capturing the third frame image F3. The process goes then on in this manner. This allows dynamic adjustment of exposure periods of intensity detecting pixels 51b in a frame to frame manner, either by setting all exposure periods for all pixels at the beginning of the frame period or by providing control signals at the times where exposures by pixel subgroups with their own exposure periods are started.

According to a second, principal example the control unit is configured to count events detected during a current exposure period and to end the exposure period, when the number of detected events reaches a predetermined value. This is exemplified in FIGS. 25 to 27.

Here, FIG. 25 refers to a parallel exposure scheme, where different short exposure periods EP2-1, EP2-2, EP2-3 can be set to different pixel groups, as discussed above with respect to FIG. 22 b). Each of these exposure periods EP2-1, EP2-2, EP2-3 is set in the same manner. Input windows I1, I2, I3 are set during which events are counted. Once the number of detected events reaches a predetermined value, exposure of the intensity detecting pixels 51b that started exposure the earliest is stopped by the control unit 40, which also means that the input window ends at this point in time. The exposure period obtained in this manner defines the exposure periods for all intensity detecting pixels 51b in the respective pixel group.

If the predetermined value is not reached, the second exposure period EP2 may have the same length as the first exposure period EP1. Moreover the predetermined value may differ between different pixel groups and may be defined by the control unit e.g. based on the event data obtained during capturing of the previous frame image F. Otherwise, i.e. if the predetermined value is the same, the length of the second exposure period EP2 will be determined by the temporal distribution of the events.

In the example of FIG. 25 the first four pixel rows share one short exposure period EP2-1, the second four pixel rows share one short exposure period EP2-2 and the last four pixel rows also share one short exposure period EP2-3. While the predetermined value of events is reached in the first and the last four pixel rows, this is not the case for the second four pixel rows. Accordingly, the respective “short” exposure period EP2-2 has the same length as the constant “long” exposure period EP1.

While in the first input window I1 events are concentrated rather at the beginning of the first input window I1, in the third input window I3 the events have a larger temporal spread. Accordingly, the short exposure period EP2-1 of the first four pixel rows is shorter than the exposure period EP2-3 of the last four pixel rows.

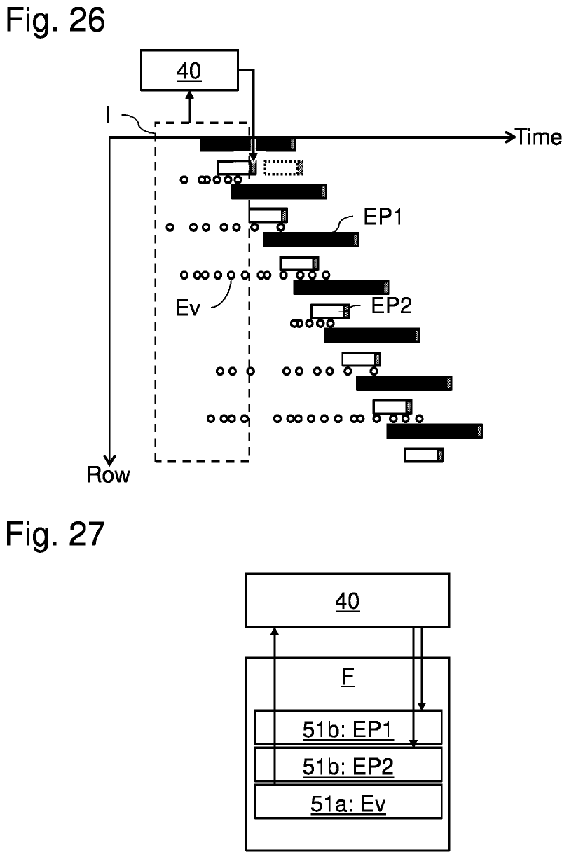

It is apparent that the same principle can also be applied to globally adjust the second exposure period EP2. This is shown in FIG. 26, where the input window I comprises the entire pixel array and ends when the number of events reaches the predetermined number. When this happens, the control unit 40 ends the exposure of the first pixel row and sets the exposure period obtained in this manner as the exposure period EP2 for all intensity detecting pixels 51b.

In this manner, the exposure period can be adjusted during the currently ongoing exposure, i.e. during capturing of a single frame image. This further reduces the latency of the adaption, since it is not necessary to wait for the complete readout of an entire frame before exposure periods are adjusted.

Further, it has to be noted that although the above was described with respect to at least two different exposure periods, the above principle can also be applied to the case where only a single exposure period is present. For example, in a pixel-wise exposure adjustment as discussed above with respect to FIG. 17, the events assignable to each intensity detecting pixel 51b may be counted separately and exposure of each intensity detecting pixel 51b may be stopped, once a predetermined number of events has been counted. Otherwise, the intensity detecting pixel 51b will be exposed for a maximum exposure period. In this manner, it is possible to adjust exposure periods EP pixel-wise within one frame period, i.e. with reduced latency.

Here, it should be noted that the control unit may be configured to adjust the frame periods concurrently with the exposure periods. This means, also in an exposure adjustment “on the fly” it will be possible to increase the frame rate by adding additional readout cycles as discussed above with respect to FIG. 20. This is for example indicated in FIG. 26 by the additional exposure period shown with broken lines in the first row. The exposure period of this additional readout cycle may again be set based on an input window I or may just stay the same, for example until a full frame image is read out.

FIG. 27 provides a summarized overview of the above described processes. As shown in FIG. 27 event data Ev are provided from the event detecting pixels 51a:Ev to the control unit 40 while a frame image F is captured. The control unit 40 adjusts the exposure periods of the different sets of intensity detecting pixels 51b:EP1, 51b:EP2 also during capturing of the frame image F. As discussed above, although two sets of intensity detecting pixels 51b are shown in FIG. 27, there may also be only a single, but freely adjustable exposure period for each pixel or there may be more than two such sets.

In the above process of terminating exposure periods EP when a predetermined number of events for the respective group of intensity detecting pixels 51b has been reached, there is in principle the possibility that exposure of different pixels/pixel groups ends concurrently, such that different readout processes R would have to be carried out at the same time. Since this is not possible, information might be lost if such a concurrent ending of exposure periods EP occurs.

To avoid this situation the control unit 40 may be configured to extend exposure periods EP beyond the point in time at which the number of events reached the predetermined value, if the pixel signal generating circuitry 30 is at that point in time occupied with another readout process R.

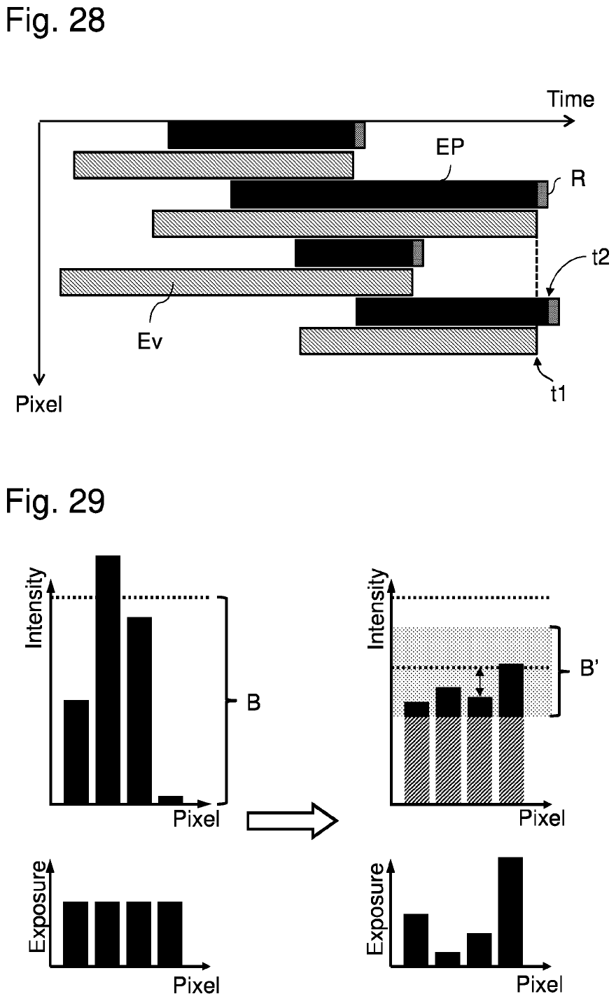

This is schematically exemplified in FIG. 28. FIG. 28 shows some exposure periods EP for different intensity detecting pixels 51b that are each terminated, when the events detected by assigned event detecting pixels 51a reach a predetermined value. As indicated by the broken line, two exposure periods EP end at the same time t1. Then, the control unit 40 is configured to carry on exposure with one of the pixels until the readout process R for the other pixel has been finished. Thus, one exposure period EP is extended to the time t2 in FIG. 28. Notification of occupancy of the pixel signal generating circuitry 30 may be carried out e.g. by setting a flag in the control unit 40 during each readout process R, and by not terminating exposure periods as long as the flag is set.

In the above discussion it was often assumed that the control unit 40 merely counts events in order to adjust exposure periods. However, the control unit 40 may also be configured to estimate the illumination of intensity detecting pixels 51b within the current frame period by extrapolating the intensity values obtained in the previous frame period based on the events that have been detected after the beginning, preferably after the end of the previous frame period, and to adjust the current exposure periods based on the estimated illumination.

The control unit 40 is therefore capable to use the event data Ev as well as the pixel signals (of one or of several sets) generated during capturing of one image frame to predict brightness levels and/or motion to be expected during capturing of the next image frame. The exposure periods EP are then adjusted such as to avoid overexposure, underexposure and/or motion blur to an extent as much as possible. The prediction might here be based on a simple extrapolation, like taking for each pixel a measured intensity value, adding the event detection threshold for each positive polarity event detected since the measurement and subtracting the threshold for each negative polarity event detected since the measurement. But the prediction might also be based on more sophisticated algorithms, e.g. based on an artificial intelligence model like a neural network.

In principle, the goal of the estimation is to set the intensity measured by each intensity detecting pixel 51b to a predefined value. The different intensities to be seen in the frame image would then be purely dictated by the values of the exposure periods of the different intensity detecting pixels 51b. In practice, this will hardly be possible due to unforeseeable changes in the observed scene.

However, what can be achieved in the above manner is that the control unit 40 is configured to adjust the exposure periods EP such that the intensity values obtained by the intensity detecting pixels 51b are within a predetermined intensity range B′.

This is illustrated exemplarily in FIG. 29. Here, the left hand side shows the intensities measured with four intensity detecting pixels 51b, if a uniform exposure is applied. This leads to overexposure of the second pixel and underexposure of the fourth pixel.

Taking account of intensity values of the previous image frame and the concurrently detected events, brightness level for each of the four intensity detecting pixels 51b can be estimated. These brightness levels lead for example to exposure periods as shown at the bottom right of FIG. 29. These exposure periods bring the intensity values detected by each of the intensity detecting pixels 51b within a predetermined intensity range B′ that is smaller than the intensity range B (zero to maximal intensity) that needs to be addressed without exposure adaption.

An ADC operating on the electrical signal generated by each of the intensity detecting pixels will therefore have to cover only the smaller range B′ which makes the ADC process more efficient, i.e. faster or less power consuming.

Here, it should be noted that the intensity values shown in the frame image will not be the ones measured by the intensity detecting pixels 51b. Instead, the measured intensities must be corrected based on the different exposure periods to obtain the original intensity distribution shown at the top left of FIG. 29. However, this is a computational step that is based on the numerical values of the exposure periods. These numerical values will not suffer from overexposure or underexposure as would be the case for the pixel signals obtained for uniform exposure. Thus, by adjusting the exposure periods and by deducing the true intensities afterwards from the measured intensities and the values of the exposure periods, the dynamic range of the frame images can be increased.

Here, it has to be understood that although the above description focuses mainly on brightness levels, the same principles could also be applied to reduce motion blur, i.e. events can be used to predict an amount of motion that lead to adjustment of the exposure periods.

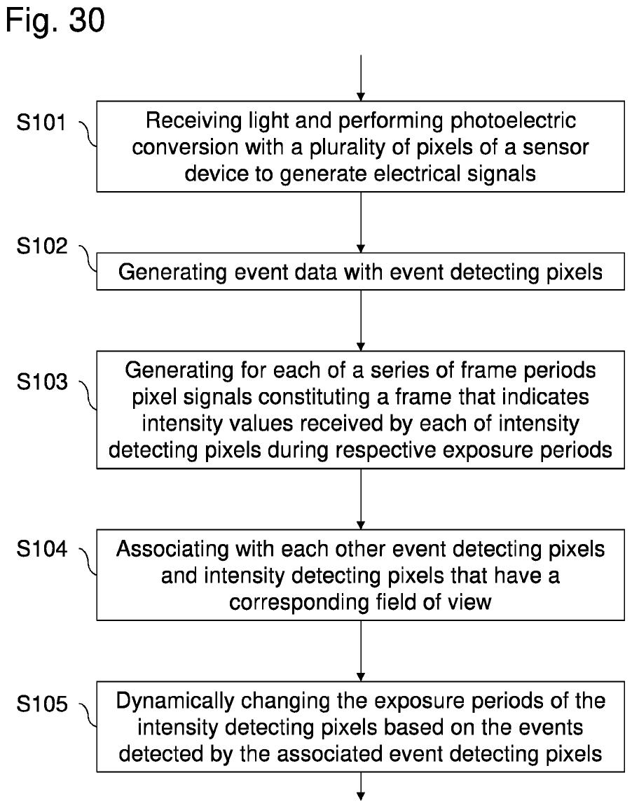

FIG. 30 shows a schematic process flow of a method for operating a sensor device 10 that summarizes the methods described above.

At S101 light is received and photoelectric conversion is performed with each of a plurality of pixels 51 of the sensor device 10 to generate an electrical signal.

At S102 event data are generated with event detection circuitry 20 of the sensor device by detecting as events intensity changes above a predetermined threshold of the light received by each of event detecting pixels 51a that form a first subset of the pixels 51.

At S103 for each of a series of frame periods pixel signals are generated with pixel signal generating circuitry 30, which pixel signals constitute a frame image that indicates intensity values of the light received by each of intensity detecting pixels 51b that form a second subset of the pixels 51 during respective exposure periods.

At S104 event detecting pixels 51a and intensity detecting pixels 51b that have a corresponding field of view are associated with each other.

At S105 the exposure periods of the intensity detecting pixels 51b are dynamically changed based on the events detected by the associated event detecting pixels 51a.

In this manner it is possible to adjust the exposure periods in a low latency manner such as to generate improved frame images with less motion blur and/or a high dynamic range.

The technology according to the above (i.e. the present technology) is applicable to various products. For example, the technology according to the present disclosure may be realized as a device that is installed on any kind of moving bodies, for example, vehicles, electric vehicles, hybrid electric vehicles, motorcycles, bicycles, personal mobilities, airplanes, drones, ships, and robots.

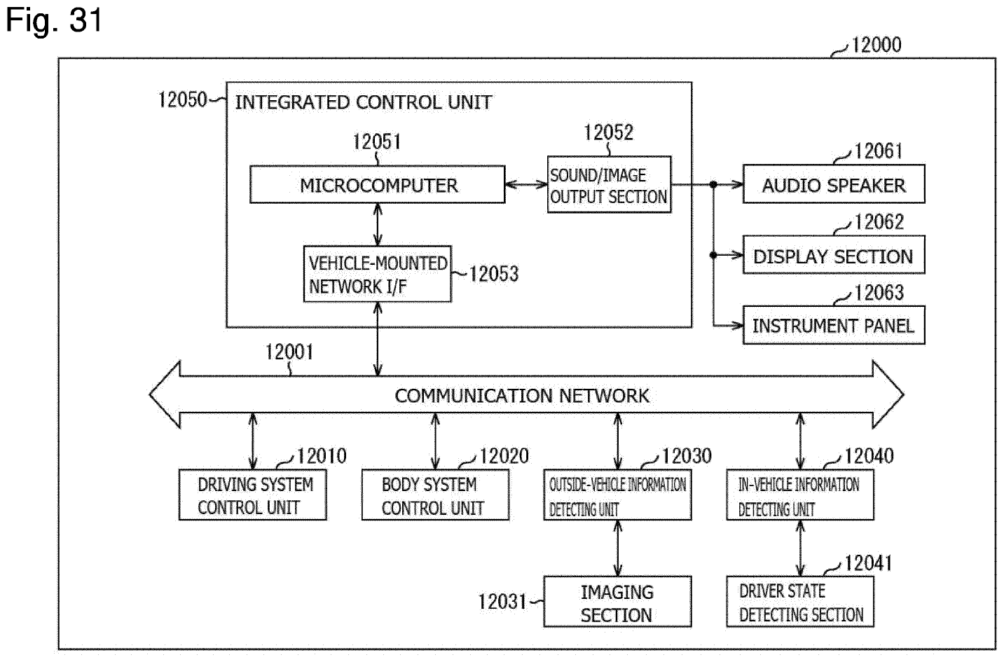

FIG. 31 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 31, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automatic driving, which makes the vehicle to travel autonomously without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 31, an audio speaker 12061, a display section 12062, and an instrument panel 12063 are illustrated as the output device. The display section 12062 may, for example, include at least one of an on-board display and a head-up display.

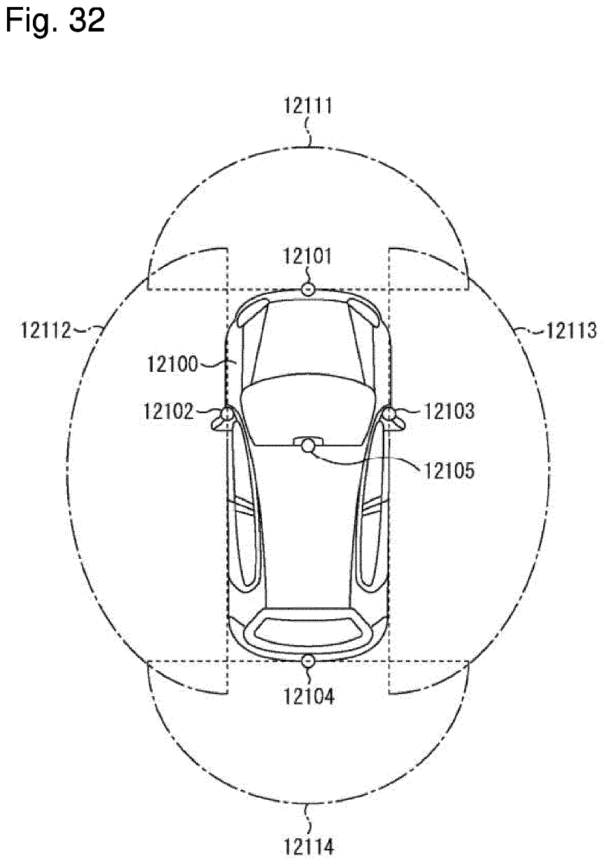

FIG. 32 is a diagram depicting an example of the installation position of the imaging section 12031.

In FIG. 32, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 32 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automatic driving that makes the vehicle travel autonomously without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure is applicable has been described above. The technology according to the present disclosure is applicable to the imaging section 12031 among the above-mentioned configurations. Specifically, the sensor device 10 is applicable to the imaging section 12031. The imaging section 12031 to which the technology according to the present disclosure has been applied flexibly acquires event data and performs data processing on the event data, thereby being capable of providing appropriate driving assistance.

Note that, the embodiments of the present technology are not limited to the above-mentioned embodiment, and various modifications can be made without departing from the gist of the present technology.

Further, the effects described herein are only exemplary and not limited, and other effects may be provided.

Note that, the present technology can also take the following configurations.

1. A sensor device comprising:
a plurality of pixels each configured to receive light and perform photoelectric conversion to generate an electrical signal;
event detection circuitry that is configured to generate event data by detecting as events intensity changes above a predetermined threshold of the light received by each of event detecting pixels that form a first subset of the pixels;
pixel signal generating circuitry that is configured to generate for each of a series of frame periods pixel signals constituting a frame image that indicates intensity values of the light received by each of intensity detecting pixels that form a second subset of the pixels during respective exposure periods; and
a control unit that is configured to associate with each other event detecting pixels and intensity detecting pixels that have a corresponding field of view and to dynamically change the exposure periods of the intensity detecting pixels based on the events detected by the associated event detecting pixels.

2. The sensor device according to 1, wherein
the control unit is configured to deduce an amount of motion and/or a brightness level from the events detected by the event detecting pixels; and
a larger amount of motion and/or a larger brightness level leads to a shorter exposure period, while a smaller amount of motion and/or a smaller brightness level leads to a longer exposure period.

3. The sensor device according to any one of 1 to 2, wherein
the control unit is configured to adjust the exposure period of each intensity detecting pixel separately.

4. The sensor device according to any one of 1 to 3, wherein
the pixel signal generating circuitry generates during each frame period at least two sets of pixel signals with at least two differing exposure periods; and
the control unit is configured to adjust the shorter exposure period, while the longer exposure period is fixed.

5. The sensor device according to 4, wherein
the control unit is configured to set different frame periods for each set of pixel signal and to adjust the frame periods concurrently with the exposure periods.

6. The sensor device according to any one of 4 to 5, wherein
the intensity detecting pixels are arranged in a two dimensional array comprising a plurality of rows; and
the control unit is configured to read out pixel signals of the intensity detecting pixels in a row based manner such that for each row pixel signals of different exposure periods are generated simultaneously; or
the control unit is configured to read out pixel signals of the intensity detecting pixels in a row based manner such that for each row pixel signals of different exposure periods are read out consecutively.

7. The sensor device according to any one of 4 to 6, wherein
the control unit is configured to execute a neural network that receives for each frame period all sets of pixel signals and the event data generated during the frame period and outputs a frame image.

8. The sensor device according to any one of 1 to 7, wherein
the control unit is configured to set with a single command the same exposure period for all intensity detecting pixels; or
the control unit is configured to set different exposure periods in different parts of a frame image.

9. The sensor device according to any one of 1 to 8, wherein
the control unit is configured to adjust the frame periods concurrently with the exposure periods.

10. The sensor device according to any one of 1 to 9, wherein
the control unit is configured to evaluate the events detected during a current frame period and to adjust the exposure periods within the next frame period based on the result of the evaluation; or
the control unit is configured to count events detected during a current exposure period and to end the exposure period, when the number of events reaches a predetermined value.

11. The sensor device according to 10, wherein
the control unit is configured to extend the exposure period beyond the point in time at which the number of events reached the predetermined value, if the pixel signal generating circuitry is at that point in time occupied with another readout process.

12. The sensor device according to any one of 1 to 11, wherein
the control unit is configured to estimate the illumination of intensity detecting pixels within the current frame period by extrapolating the intensity values obtained in the previous frame period based on the events that have been detected after the beginning, preferably after the end of the previous frame period, and to adjust the current exposure periods based on the estimated illumination.

13. The sensor device according to 12, wherein
the control unit is configured to adjust the exposure periods such that the intensity values obtained by the intensity detecting pixels are within a predetermined intensity range.

14. The sensor device according to any one of 1 to 13, wherein
the first subset of pixels overlaps or is equal to the second subset of pixels; or
the event detecting pixels and the intensity detecting pixels are different from each other.

15. A method for operating a sensor device, the method comprising:
receiving light and performing photoelectric conversion with each of a plurality of pixels of the sensor device to generate an electrical signal;
generating, with event detection circuitry of the sensor device, event data by detecting as events intensity changes above a predetermined threshold of the light received by each of event detecting pixels that form a first subset of the pixels;
generating, with pixel signal generating circuitry, for each of a series of frame periods pixel signals constituting a frame image that indicates intensity values of the light received by each of intensity detecting pixels that form a second subset of the pixels during respective exposure periods;
associating with each other event detecting pixels and intensity detecting pixels that have a corresponding field of view; and
dynamically changing the exposure periods of the intensity detecting pixels based on the events detected by the associated event detecting pixels.

1. A sensor device comprising:
a plurality of pixels each configured to receive light and perform photoelectric conversion to generate an electrical signal;
event detection circuitry that is configured to generate event data by detecting as events intensity changes above a predetermined threshold of the light received by each of event detecting pixels that form a first subset of the pixels;
pixel signal generating circuitry that is configured to generate for each of a series of frame periods pixel signals constituting a frame image that indicates intensity values of the light received by each of intensity detecting pixels that form a second subset of the pixels during respective exposure periods; and
a control unit that is configured to associate with each other event detecting pixels and intensity detecting pixels that have a corresponding field of view and to dynamically change the exposure periods of the intensity detecting pixels based on the events detected by the associated event detecting pixels.

2. The sensor device according to claim 1, wherein
the control unit is configured to deduce an amount of motion and/or a brightness level from the events detected by the event detecting pixels; and
a larger amount of motion and/or a larger brightness level leads to a shorter exposure period, while a smaller amount of motion and/or a smaller brightness level leads to a longer exposure period.

3. The sensor device according to claim 1, wherein
the control unit is configured to adjust the exposure period of each intensity detecting pixel separately.

4. The sensor device according to claim 1, wherein
the pixel signal generating circuitry generates during each frame period at least two sets of pixel signals with at least two differing exposure periods; and
the control unit is configured to adjust the shorter exposure period, while the longer exposure period is fixed.

5. The sensor device according to claim 4, wherein
the control unit is configured to set different frame periods for each set of pixel signal and to adjust the frame periods concurrently with the exposure periods.

6. The sensor device according to claim 4, wherein
the intensity detecting pixels are arranged in a two dimensional array comprising a plurality of rows; and
the control unit is configured to read out pixel signals of the intensity detecting pixels in a row based manner such that for each row pixel signals of different exposure periods are generated simultaneously; or
the control unit is configured to read out pixel signals of the intensity detecting pixels in a row based manner such that for each row pixel signals of different exposure periods are read out consecutively.

7. The sensor device according to claim 4, wherein
the control unit is configured to execute a neural network that receives for each frame period all sets of pixel signals and the event data generated during the frame period and outputs a frame image.

8. The sensor device according to claim 1, wherein
the control unit is configured to set with a single command the same exposure period for all intensity detecting pixels; or
the control unit is configured to set different exposure periods in different parts of a frame image.

9. The sensor device according to claim 1, wherein
the control unit is configured to adjust the frame periods concurrently with the exposure periods.

10. The sensor device according to claim 1, wherein
the control unit is configured to evaluate the events detected during a current frame period and to adjust the exposure periods within the next frame period based on the result of the evaluation; or
the control unit is configured to count events detected during a current exposure period and to end the exposure period, when the number of events reaches a predetermined value.

11. The sensor device according to claim 10, wherein
the control unit is configured to extend the exposure period beyond the point in time at which the number of events reached the predetermined value, if the pixel signal generating circuitry is at that point in time occupied with another readout process.

12. The sensor device according to claim 1, wherein
the control unit is configured to estimate the illumination of intensity detecting pixels within the current frame period by extrapolating the intensity values obtained in the previous frame period based on the events that have been detected after the beginning, preferably after the end of the previous frame period, and to adjust the current exposure periods based on the estimated illumination.

13. The sensor device according to claim 12, wherein
the control unit is configured to adjust the exposure periods such that the intensity values obtained by the intensity detecting pixels are within a predetermined intensity range.

14. The sensor device according to claim 1, wherein
the first subset of pixels overlaps or is equal to the second subset of pixels; or
the event detecting pixels and the intensity detecting pixels are different from each other.

15. A method for operating a sensor device, the method comprising:
receiving light and performing photoelectric conversion with each of a plurality of pixels of the sensor device to generate an electrical signal;
generating, with event detection circuitry of the sensor device, event data by detecting as events intensity changes above a predetermined threshold of the light received by each of event detecting pixels that form a first subset of the pixels;
generating, with pixel signal generating circuitry, for each of a series of frame periods pixel signals constituting a frame image that indicates intensity values of the light received by each of intensity detecting pixels that form a second subset of the pixels during respective exposure periods;
associating with each other event detecting pixels and intensity detecting pixels that have a corresponding field of view; and
dynamically changing the exposure periods of the intensity detecting pixels based on the events detected by the associated event detecting pixels.
